(19) United States
(12) Patent Application Publication
(10) Pub. No.: US 2026/0111733 A1
(43) Pub. Date: Apr. 23, 2026

(54) ADAPTIVE ERROR-GUIDED CACHING FOR DIFFUSION TRANSFORMERS

(71) Applicant: Roblox Corporation, San Mateo, CA (US)

(72) Inventors: Joshua Alexander GEDDES, Oakville (CA); Joseph LIU, San Francisco, CA (US); Ziyu GUO, San Mateo, CA (US); Haomiao JIANG, San Mateo, CA (US); Mubbasir Turab KAPADIA, San Mateo, CA (US); Mahesh Kumar NANDWANA, Sunnyvale, CA (US); Yiheng ZHU, San Mateo, CA (US); Charles SHANG, San Mateo, CA (US)

(73) Assignee: Roblox Corporation, San Mateo, CA (US)

(21) Appl. No.: 19/061,667

(22) Filed: Feb. 24, 2025

Related U.S. Application Data
(60) Provisional application No. 63/709,305, filed on Oct. 18, 2024.

(51) Int. Cl. G06N 3/082; G06T 5/60; G06T 5/70; G10L 21/0208

(52) U.S. Cl. CPC G06N 3/082; G06T 5/60; G06T 5/70; G10L 21/0208

(57) ABSTRACT

An adaptive error-guided caching technique accelerates inference for a diffusion model that includes blocks, each block including one or more layers. A first pass of the diffusion model is performed to obtain a first-pass output. For subsequent passes, a data structure indicates skippable layers in the blocks. Based on the data structure, a given pass uses pass output from an immediately preceding pass to obtain a pass output by executing one or more specified layers or reuses output from respective layer output values for the specified layers to lower a computational cost. At the final pass, the diffusion model provides the inference output. The data structure used to manage execution may be obtained based on one or more calibration runs, where the calibration runs determine values of a loss function for layers between passes and uses these values to establish which layers use cached information in passes.

### CROSS-REFERENCE TO RELATED APPLICATIONS

This application claims priority to U.S. Provisional Application No. 63/709,305, entitled “ADAPTIVE ERROR-GUIDED CACHING FOR DIFFUSION TRANSFORMERS,” filed on Oct. 18, 2024, the content of which is incorporated herein in its entirety.

### TECHNICAL FIELD

This disclosure relates generally to machine learning, and more particularly but not exclusively, relates to methods, systems, and computer readable media to provide an improvement to diffusion transformers, where adaptive error-guided caching techniques improve the performance of the diffusion transformers.

### BACKGROUND

Diffusion models iteratively remove noise from a feature map to generate output. Diffusion transformers are special generation models that use scalable attention blocks. They may be used, as examples, for image, video, sound, and 3D/4D generative artificial intelligence (GenAI).

Diffusion transformers have recently shown to be a highly effective model architecture for image, video, and speech generation tasks due to the scalability of the transformer mechanism. However, diffusion transformer post-training inference is computationally costly, largely in part due to the expensive transformer modules (for example, attention and feedforward modules) that are computed for every model evaluation.

Many works have proposed solutions that aim to reduce the number of steps in the diffusion process, and more recently, have proposed caching and reusing features cross timestep. While these works have shown benefits of caching, existing caching methods either perform poorly or are non-generalizable to different model architectures and modalities.

Some implementations were conceived in light of the above.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

Implementations of the present disclosure relate to techniques of providing a generalized solution towards a diffusion transformer caching scheme to improve the inference performance. The techniques use adaptive caching, a caching technique that uses layer-wise output loss collected from one or more small calibration inference pass(es) to decide when and where to perform caching.

Such caching may improve the speed of using a diffusion transformer with a manageable degradation of quality. The adaptive caching may be useful in speeding up various applications of diffusion transformers, such as image denoising and generation, video denoising and generation, speech processing and generation, and audio processing and generation (e.g., generation of sound effects and non-verbal sounds).

For example, the techniques may provide a way to obtain inference output from a diffusion model that includes a plurality of blocks, each block including one or more layers. As examples, these blocks could include a self-attention layer and a feedforward layer (i.e., the diffusion model may include diffusion transformer blocks having such layers).

However, these are only examples of possible layers and blocks, and the techniques discussed herein apply to any diffusion transformer model with computationally intensive common/unitary components and/or layers within the transformer block(s). For example, a transformer block might have two separate feedforward layers and a self-attention layer in a block, or one feedforward layer, one self-attention layer, and one cross attention layer in a given transformer block.

Other examples could include specific transformer blocks used for specific use cases. For example, there may be a diffusion model that performs text to video generation. Such a diffusion model may include spatial and temporal elements. For example, the spatial elements may include a spatial self-attention layer, a spatial feedforward network layer, and a spatial cross attention layer. The temporal elements may include a temporal self-attention layer, a temporal feedforward layers, and a temporal cross attention layer. These layers may be organized into various blocks for each model pass.

Alternatively, there may be a diffusion model that performs text to audio generation. Such a diffusion model may include an attention cache layer, a multi-layer perceptron (or feedforward) cache layer, and a cross attention cache layer. These layers may be organized into various blocks for each model pass.

An initial pass of the diffusion model is performed. Subsequently, a data structure (i.e., a caching schedule) can be accessed to determine whether to execute the respective layers within the diffusion transformer blocks at each timestep. If the data structure indicates to execute the respective layers within the diffusion transformer blocks, another pass of the diffusion is model is performed based on executing such layers within the diffusion transformer blocks. If the data structure indicates to not execute such layers within the diffusion transformer blocks, another pass of the diffusion is model is performed based on previous layer output values for such layers. Each layer may have its own caching schedule, so in some model passes it may be possible to cache some layers in the model but not others.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

According to one aspect, a computer-implemented method to obtain inference output from a diffusion model that includes a plurality of blocks (N), each block including one or more layers, and wherein obtaining the inference output is by performing a plurality of sequential passes of the diffusion model is provided, the method comprising: performing a first pass of the diffusion model by executing the plurality of blocks to obtain a first-pass output; for each subsequent pass, determining whether to execute one or more specified layers in the plurality of blocks based on a data structure that indicates skippable layers; if it is determined to execute the one or more specified layers in the plurality of blocks, performing a pass of the diffusion model based on previous pass output from an immediately preceding pass by executing the one or more specified layers in the plurality of blocks to obtain outputs for the one or more specified layers; and if it is determined to not execute the one or more specified layers in the plurality of blocks, performing the pass of the diffusion model based on the previous pass output from the immediately preceding pass by accessing respective layer output values for the one or more specified layers in the plurality of blocks from the immediately preceding pass, wherein a computational cost associated with accessing the respective layer output values is lower than a computational cost associated with executing the one or more specified layers; and at a final pass, receiving the inference output at an output layer of the diffusion model.

Various implementations of the computer-implemented method are described herein.

In some implementations, the diffusion model is an image generation model that generates an output image by denoising a noisy input image, and wherein performing the first pass comprises performing the first pass using the noisy input image as an input to the diffusion model.

In some implementations, the diffusion model is a speech-to-speech model that generates output speech based on input speech.

In some implementations, each pass of the plurality of sequential passes of the diffusion model is associated with a respective timestep, and wherein the data structure is indexed by the timestep, such that the data structure indicates whether the one or more specified layers in the plurality of blocks are to be executed for the timestep.

In some implementations, the computer-implemented method further comprises generating the data structure that indicates whether to execute the one or more specified layers by performing one or more calibration runs, wherein each calibration run comprises: performing a plurality of sequential calibration passes of the diffusion model by executing the one or more layers of the plurality of blocks to obtain respective calibration pass output, wherein each successive calibration pass uses a previous calibration pass output as input; during the sequential calibration passes, determining a value of a loss function (E (L₁, L₂)) based on comparison of the calibration pass output for each pass of a respective layer with the calibration pass output of an immediately preceding pass for the respective layer; and if the value of the loss function meets a threshold, updating the data structure to indicate that the respective layer is skippable for the pass.

In some implementations, each calibration run further comprises if the value of the loss function does not meet the threshold, updating the data structure to indicate that the respective layer is not skippable for the pass.

In some implementations, the computer-implemented method further comprises computing error curves associated with output error of the diffusion model with respective test caching strategies for a layer; and updating the data structure based on the error curves to provide a caching schedule for the layer.

In some implementations, the diffusion model includes additional units that precede and/or succeed the plurality of blocks, and wherein the additional units are executed at each pass of the plurality of sequential passes of the diffusion model.

In some implementations, the additional units succeed the plurality of blocks and include at least one of a layer normalization unit or a linearize-and-reshape unit.

In some implementations, the additional units precede the plurality of blocks and include an embedding generation unit.

According to another aspect, a non-transitory computer-readable medium is provided. The non-transitory computer-readable medium has instructions stored thereon that, responsive to execution by a processing device, causes the processing device to perform a computer-implemented method to obtain inference output from a diffusion model that includes a plurality of blocks (N), each block including one or more layers, and wherein obtaining the inference output is by performing a plurality of sequential passes of the diffusion model by performing operations comprising: performing a first pass of the diffusion model by executing the plurality of blocks to obtain a first-pass output; for each subsequent pass, determining whether to execute one or more specified layers in the plurality of blocks based on a data structure that indicates skippable layers; if it is determined to execute the one or more specified layers in the plurality of blocks, performing a pass of the diffusion model based on previous pass output from an immediately preceding pass by executing the one or more specified layers in the plurality of blocks to obtain outputs for the one or more specified layers; and if it is determined to not execute the one or more specified layers in the plurality of blocks, performing the pass of the diffusion model based on the previous pass output from the immediately preceding pass by accessing respective layer output values for the one or more specified layers in the plurality of blocks from the immediately preceding pass, wherein a computational cost associated with accessing the respective layer output values is lower than a computational cost associated with executing the one or more specified layers; and at a final pass, receiving the inference output at an output layer of the diffusion model.

Various implementations of the non-transitory computer-readable medium are described herein.

In some implementations, the instructions cause the processing device to perform further operations comprising generating the data structure that indicates whether to execute the one or more specified layers by performing one or more calibration runs, wherein each calibration run comprises: performing a plurality of sequential calibration passes of the diffusion model by executing the one or more layers of the plurality of blocks to obtain respective calibration pass output, wherein each successive calibration pass uses a previous calibration pass output as input; during the sequential calibration passes, determining a value of a loss function (E (L₁, L₂)) based on comparison of the calibration pass output for each pass of a respective layer with the calibration pass output of an immediately preceding pass for the respective layer; and if the value of the loss function meets a threshold, updating the data structure to indicate that the respective layer is skippable for the pass.

In some implementations, the instructions cause the processing device to perform further operations further comprising computing error curves associated with output error of the diffusion model with respective test caching strategies for a layer; and updating the data structure based on the error curves to provide a caching schedule for the layer.

In some implementations, the diffusion model includes additional units that precede and/or succeed the plurality of blocks, and wherein the additional units are executed at each pass of the plurality of sequential passes of the diffusion model.

In some implementations, the additional units succeed the plurality of blocks and include at least one of a layer normalization unit or a linearize-and-reshape unit.

In some implementations, the additional units precede the plurality of blocks and include an embedding generation unit.

According to another aspect, a system disclosed, comprising: a memory with instructions stored thereon; and a processing device, coupled to the memory, the processing device configured to access the memory and execute the instructions, wherein the instructions cause the processing device to perform a computer-implemented method to obtain inference output from a diffusion model that includes a plurality of blocks (N), each block including one or more layers, and wherein obtaining the inference output is by performing a plurality of sequential passes of the diffusion model by performing operations comprising: performing a first pass of the diffusion model by executing the plurality of blocks to obtain a first-pass output; for each subsequent pass, determining whether to execute one or more specified layers in the plurality of blocks based on a data structure that indicates skippable layers; if it is determined to execute the one or more specified layers in the plurality of blocks, performing a pass of the diffusion model based on previous pass output from an immediately preceding pass by executing the one or more specified layers in the plurality of blocks to obtain outputs for the one or more specified layers; and if it is determined to not execute the one or more specified layers in the plurality of blocks, performing the pass of the diffusion model based on the previous pass output from the immediately preceding pass by accessing respective layer output values for the one or more specified layers in the plurality of blocks from the immediately preceding pass, wherein a computational cost associated with accessing the respective layer output values is lower than a computational cost associated with executing the one or more specified layers; and at a final pass, receiving the inference output at an output layer of the diffusion model.

Various implementations of the system are described herein.

In some implementations, the instructions cause the processing device to perform further operations comprising generating the data structure that indicates whether to execute the one or more specified layers by performing one or more calibration runs, wherein each calibration run comprises: performing a plurality of sequential calibration passes of the diffusion model by executing the one or more layers of the plurality of blocks to obtain respective calibration pass output, wherein each successive calibration pass uses a previous calibration pass output as input; during the sequential calibration passes, determining a value of a loss function (E (L₁, L₂)) based on comparison of the calibration pass output for each pass of a respective layer with the calibration pass output of an immediately preceding pass for the respective layer; and if the value of the loss function meets a threshold, updating the data structure to indicate that the respective layer is skippable for the pass.

In some implementations, the instructions cause the processing device to perform further operations further comprising computing error curves associated with output error of the diffusion model with respective test caching strategies for a layer; and updating the data structure based on the error curves to provide a caching schedule for the layer.

In some implementations, the diffusion model includes additional units that precede and/or succeed the plurality of blocks, and wherein the additional units are executed at each pass of the plurality of sequential passes of the diffusion model.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF THE DRAWINGS

FIG. 1 is a diagram illustrating an example of using a diffusion transformer over multiple timesteps to perform denoising, in accordance with some implementations.

FIG. 2 is a diagram illustrating an example of successive passes processed by a diffusion transformer that are similar in layer output, in accordance with some implementations.

FIG. 3 is a diagram illustrating an example of reusing information in a diffusion transformer by caching, in accordance with some implementations.

FIG. 4 is a diagram illustrating an example of managing caching based on differences between successive model passes, in accordance with some implementations.

FIG. 5 is a diagram illustrating an example of diffusion transformer output without caching and with error-guided adaptive caching, in accordance with some implementations.

FIG. 6 is a diagram illustrating examples of various outputs of a diffusion transformer used to generate images, with and without error-guided adaptive caching, in accordance with some implementations.

FIG. 7A is a graph illustrating relationships between error values and timesteps based on skipping certain numbers of blocks, in accordance with some implementations.

FIG. 7B is markup language defining skipping certain numbers of blocks in a video generation use case, in accordance with some implementations.

FIG. 7C is additional markup language defining skipping certain numbers of blocks in an audio generation use case, in accordance with some implementations.

FIG. 8A is a diagram illustrating the structure of a diffusion transformer, in accordance with some implementations.

FIG. 8B is a diagram illustrating the structure of a diffusion transformer block, in accordance with some implementations.

FIG. 9 illustrates a flowchart of an example computer-implemented method to provide error-guided adaptive caching to diffusion transformers, in accordance with some implementations.

FIG. 10 illustrates a sequence of units in a diffusion model, in accordance with some implementations.

FIG. 11 illustrates a sequence of stages in processing where the diffusion model handles an image, in accordance with some implementations.

FIG. 12 illustrates a sequence of stages in processing where the diffusion model handles speech, in accordance with some implementations.

FIG. 13 illustrates a flowchart of a method to perform a calibration run and use the calibration run as the basis of storing error curves, in accordance with some implementations.

FIG. 14 illustrates a flowchart of a method to compare error curves to a threshold and identify a caching schedule accordingly, in accordance with some implementations.

FIG. 15 is a diagram of an example system architecture that allows for adaptive error-guided caching for a diffusion transformer, in accordance with some implementations.

FIG. 16 is a block diagram that illustrates an example computing device which may be used to implement one or more features described herein, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

The present disclosure is directed towards, inter alia, techniques of error-guided adaptive caching for use with diffusion models such as diffusion transformers. Diffusion models are effective for image, video, and speech generation. However, post-training inference is resource-intensive because individual models (for example, attention and feed-forward modules) are ordinarily computed for every model evaluation. To speed up the post-training inference, it may be possible to perform caching. Preferably, such caching improves performance while performing well and also being generalizable to different model architectures and modalities.

### Problem

Diffusion transformers are quite effective as a model architecture to generate images, video, and speech. The transformer mechanism is highly scalable, but post-training inference is computation intensive. Part of the computation intensity is due to the computation of every layer output (e.g., a self-attention layer output and a feedforward layer output) for every model pass. Various approaches seek to reduce the computation in the diffusion process, such as by caching and reusing features across timesteps. While some approaches have shown benefits, there are performance and generalization issues. A problem is to develop a compatible and generalizable diffusion transformer optimization technique in line with current state-of-the-art research with good performance.

### Solution

As a solution to address performance issue with diffusion transformers, some implementations propose adaptive caching, a caching technique that uses layer-wise output loss collected from a small calibration inference pass to decide where and when to perform caching. More specifically, in some implementations, a layer heuristic for two previously computed layers is used to guide how the cache schedule operates.

The heuristic can be calculated as the relative L1 norm between the same layer in two subsequent timesteps. However, other heuristics may also be used that establish a difference between the output of two successive layers. The calculated heuristic is then compared to a user selected threshold a, which is used as the basis of determining when and how to use cached layers. For example, this comparison may yield a caching schedule that indicates on a layer-by-layer basis at which layers output of a given layer is to be cached and reused and at which layers output of a given layer is to be newly calculated. The L1 relative loss can also be used to calculate the error between the Nth and N+k-th layer (where k can be 1, 2, 3, 4, etc., subject to memory constraints) to determine how many layers to skip as part of the caching method.

Here, a is a user selected threshold determined on evaluated performance based on generation metrics for the specific generation domain (such as Fréchet inception distance (FID) for images, Contrastive Language-Audio Pretraining (CLAP) score for audio, etc.). This function is used to determine whether a layer output is cached based on comparing the output of the function to the threshold a.

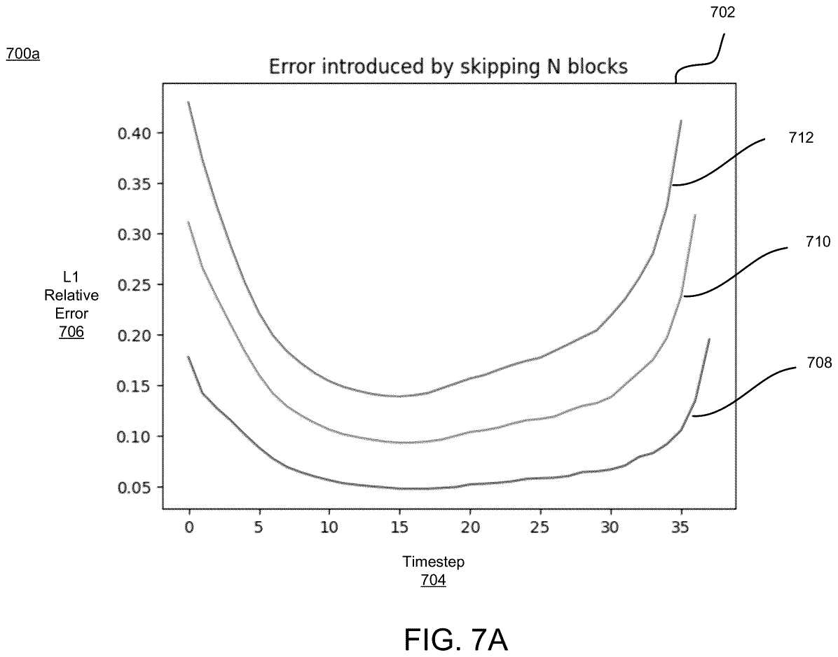

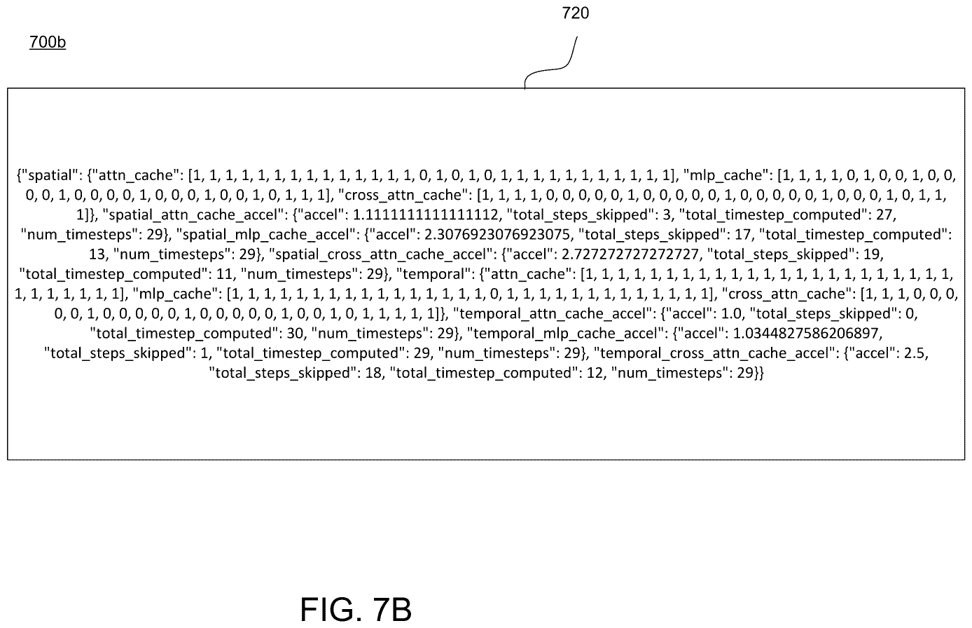

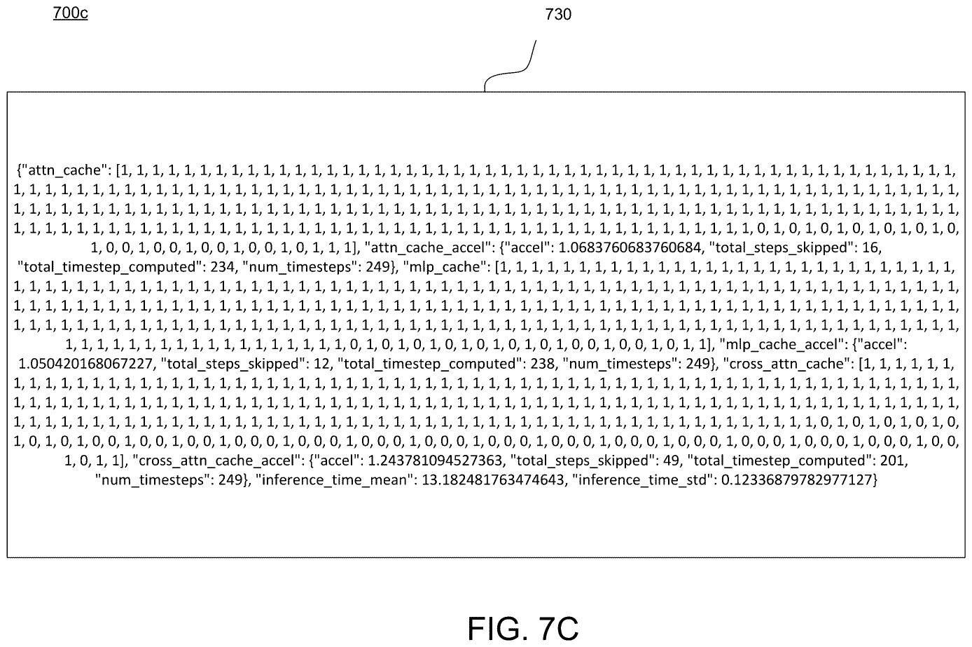

The number of layers to skip is based on computing multiple error curves based on skipping every n layers, and the highest n with error below the threshold value is used as the skip length for the given cached layer. For example, after the calibration, the error curves may be used to generate caching schedules that specify how to perform caching at inference. The caching schedules may be stored as markup language, such as JavaScript Object Notation (JSON). Examples of such error curves and caching schedules are illustrated below for image blocks at FIGS. 7A-7C.

This approach creates a caching schedule that provides a speed up of the diffusion model while minimizing performance impact. A benefit of this technique is that the curve can be generated label-free (i.e. labeled data is not necessary to generate the error curve). The only part of the pipeline that uses access to some form of dataset are evaluation datasets, to measure and compute the quality degradation of the caching scheme to identify the acceptable quality/speed tradeoff.

This means that this technique does not use access to the original training dataset and does not use any further finetuning or retraining of the original model (i.e., diffusion transformer model). However, it may be appropriate to recalibrate (and run more calibration runs) if there are changes to the model itself.

Adaptive caching offers a relative acceleration of 1.1×-1.3× (compared to using diffusion transformers without caching) with no FID increase on a diffusion transformer model over sampling with the Denoising Diffusion Implicit Model (DDIM) solver and matches or exceeds performance of other caching methods. Additionally, adaptive caching may be applied to other diffusion transformer model architectures in different domains such as domains for video and domains for speech. The caching method competes with or exceeds solver performance in the other domains as well.

### Preliminaries

In some implementations, the diffusion process transforms data x₀˜q(x₀) by adding Gaussian noise over T steps, producing a sequence x₁, x₂, . . . , x_{T}. This is modeled as a Markov chain, where each step follows: q(xₜ|xₜ₋₁)= [symbol] (xₜ; 1−βₜXₜ₋₁,βₜI), where βₜ is the noise variance at timestep t and X_{T}˜ [symbol] (0,I) due to the cumulative effect of the noise added during the diffusion steps. The task performed by the reverse process is to recover the original data x₀ from the noisy sample X_{T}. This is learned via training a neural network that parameterizes the reverse transition: p_{θ}(xₜ₋₁|xₜ)= [symbol] (xₜ₋₁; μ_{θ}(xₜ, t), Σ_{θ}(t)), where μ_{θ}(xₜ, t) is the predicted mean and Σ_{θ}(t) is the variance, both learned by training the model. The full generative process is defined as:

$${p}_{θ} ( {x}_{0 : T} ) = p ( {x}_{T} ) {\prod }_{t = 1}^{T} {p}_{θ} ( {x}_{t - 1} \vert {x}_{t} ) .$$

The generative model is trained by minimizing the variational bound on the negative log likelihood, learning to denoise xₜ at each timestep and ultimately generate samples from the learned distribution. Traditionally, p_{θ}(xₜ₋₁|xₜ) has been approximated with U-Net style model architectures, but recent works have begun to use Diffusion Transformer (DiT) architectures, which have been shown to scale better, especially for more complex tasks such as video generation. DiT architectures consist of repeated blocks containing the Self-attention, Cross-attention, and Feed-forward layers in the traditional Transformer, which are usually the computational bottleneck for both model training and inference.

A key property of diffusion models, which has driven the development of caching techniques, is the high cosine similarity between layer outputs at adjacent timesteps. This pattern of similarity is observed across a variety of generative models and solvers, spanning different modalities such as image, video, and speech diffusion. This high similarity suggests that there are computational redundancies within the diffusion process that can be leveraged to improve efficiency.

### Caching Techniques

An object of techniques presented herein is to provide a training-free, model-agnostic strategy of caching and reusing layer outputs such that minimal error is introduced. However, it may be difficult to determine a single optimal static scheme that caches cross-timestep layer output across different model architectures, solvers, and modalities. For example, when examining the average representation error between layer outputs of consecutive time steps, layers generally exhibit higher differences in later time steps in a label-to-image model, while layers in a text-to-video model may be more sensitive in the first and last diffusion time steps. Hence, it is helpful to apply a similarity principle in a generalizable technique, such that different models benefit differently based on error curves.

Let Lₜ represent the output of some layer at timestep t, and let Lₜ₋ₖ represent the output of the same layer at some future diffusion timestep t−k. By the cross-timestep layer similarity observation, Lₜ₋ₖ˜Lₜ. Thus instead of computing Lₜ₋ₖ during the diffusion process, it is possible to approximate the function using the previously computed Lₜ. Any time the layer is computed, the present techniques store Lₜ in a cache that can be accessed and used in place of future layer computations. Techniques apply caching to the aforementioned computational bottlenecks at the output that precedes a residual connection. This may include Self-attention and Feed-forward layers in a label-to-image model, Self-attention, Cross-attention, and Feed-forward layers in an audio generation model, and Self-attention, Cross-attention, and Feed-forward layers in both spatial and temporal blocks in a text-to-video model. The components may include most of the computations that occur during generation. The compute distribution may vary from model to model.

To determine whether to use a previously cached output, the following problem is defined. Let t represent the current timestep, t+k represent the timestep when the cache was previously filled, and iⱼ represent the jth layer of type i, where i∈S={attn, ffn, . . . } depending on the model architecture. The techniques are guided by the hypothesis that caching is effective if the loss between the computed and cached outputs [symbol] (Lᵢ_{ⱼ}_{,t},Lᵢ_{ⱼ}_{,t+k)}), is bounded by some layer-dependent hyper parameter αᵢ_{ⱼ}>0.

Computing [symbol] (Lᵢ_{ⱼ}_{,t},Lᵢ_{ⱼ}_{,t+k)}), is not possible without evaluating Lᵢ_{ⱼ}_{,t}, which removes any benefit from skipping the layer computation. For a given DitT architecture, it may be observed that a difference in layer representation error for two different samples is within a negligibly small threshold, with a high level of confidence. This finding suggests that the error curve for a specific model input [symbol] (Lᵢ_{ⱼ}_{,t},Lᵢ_{ⱼ}_{,t+k)}) can be closely approximated by the average error curve for an adequately large set of calibration inputs. In other words, if \tilde{L}ᵢ_{ⱼ}_{,t} represents the calibration output for layer Lᵢ_{ⱼ}_{,t}, then [symbol] (Lᵢ_{ⱼ}_{,t},Lᵢ_{ⱼ}_{,t+k)})˜ [symbol] (\tilde{L}ᵢ_{ⱼ}_{,t},\tilde{L}ᵢ_{ⱼ}_{,t+k)}).

A hyper parameter search to find all αᵢ_{ⱼ} has an exponential search space based on the number of layers and is significantly costly. In order to simplify the caching problem, techniques define a single hyper parameter α>0 to guide caching for all layers. In some implementations, [symbol] is defined as the average L1 relative error of all N layers of type i, which is selected in order to compare true representation errors between layers for all types i and positional depths j in the network. Additionally, techniques may recognize caching specific layers can introduce errors in future layers of the same type in the network. For example, if the techniques approximate Lᵢ_{_{j−1}}_{,t} with Lᵢ_{_{j−i}}_{,t+k}, this may introduce noise such that the calibration error [symbol] (\tilde{L}ᵢ_{ⱼ}_{,t},\tilde{L}ᵢ_{ⱼ}_{,t+k)}) no longer correctly approximates the true error [symbol] (Lᵢ_{ⱼ}_{,t},Lᵢ_{ⱼ}_{,t+k)}), which leads to poor caching decisions. In order to mitigate the cascading impact of caching layers, implementations may group caching decisions for all layers of type i, such that all j layers in L_{i,t+k} approximate L_{i,t}. Thus, cached output Lᵢ_{ⱼ}_{,t+k} is used in place of computing Lᵢ_{ⱼ}_{,t} when the following expression is satisfied:

$$ℒ ( {L}_{{i}_{j} , t} , {L}_{{i}_{j} , t + k )} ) ∼ \frac{1}{N} {\sum }_{j = 1}^{N} \frac{{‖ {\tilde{L}}_{{i}_{j} , t} - {\tilde{L}}_{{i}_{j} , t + k} ‖}_{1}}{{‖ {\tilde{L}}_{{i}_{j} , t} ‖}_{1}} < α .$$

Using cached outputs is computationally inexpensive, and allows for significant speedup of the diffusion inference process. As the above expression makes no prior assumptions about the specific properties of the particular diffusion process being cached, the expression can be cached across multiple architectures and modalities. Additionally, because caching decisions are only dependent on calibration error, the caching decisions do not change at model runtime. This ensures compatibility with existing graph compilation optimizations.

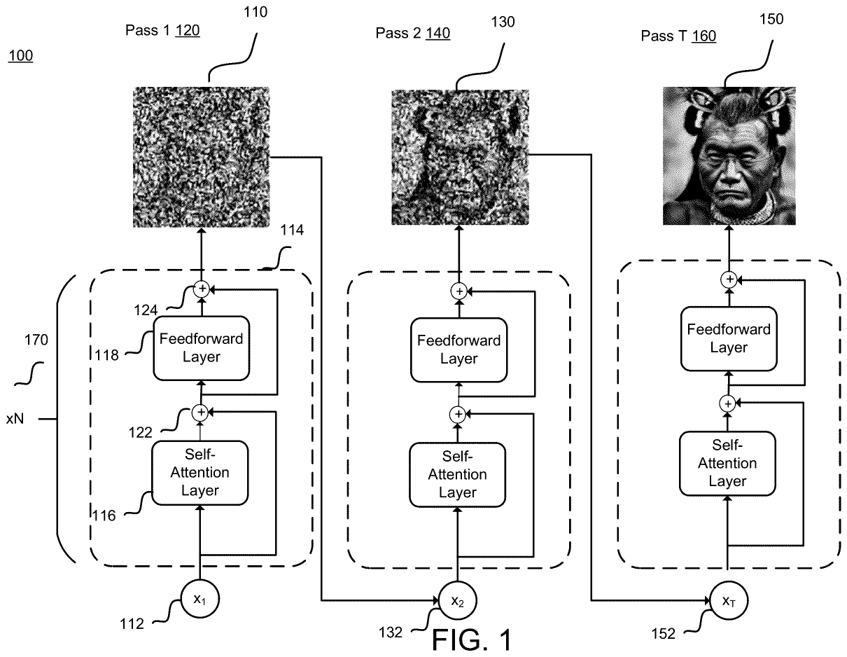

### FIG. 1—Using Diffusion Model to Perform Denoising

FIG. 1 is a diagram illustrating an example of using a diffusion model (that includes a diffusion transformer) over multiple timesteps to perform denoising 100, in accordance with some implementations. For ease of illustration, FIG. 1 illustrates only a diffusion transformer (DiT) unit 114; a diffusion model may include other blocks that precede and/or succeed the diffusion transformer blocks.

As seen in FIG. 1, in some implementations, a DiT unit 114 may include a plurality of DiT blocks. A DiT block includes self-attention layer 116, a feedforward layer 118, and combination units 122 and 124. Combination units, throughout, refer to units that take two or more inputs and combine them in various ways (such as a summation or a weighted summation) that allow multiple inputs to be combined into one value for further consideration, processing, and/or output.

Combination unit 122 combines the output of self-attention layer 116 with its input 112 (denoted as x₁). Output of combination unit 122 is provided as input to feedforward layer 118. Combination unit 124 combines the output of feedforward layer 118 and the output of combination unit 122. As illustrated in FIG. 1, a DiT unit 114 may include N DiT blocks arranged sequentially, where the output of a first block of the N DiT blocks being provided as input to a second DiT block of the N DiT blocks, and so on.

The output of the final DiT block of the N DiT blocks is a first denoised image 110. In various implementations, a plurality of sequential passes of the diffusion model are performed to iteratively denoise an image, with the denoised image at each iteration being provided as input to the next iteration. In some implementations, the first iteration (pass 1 120) may be performed with a random noisy input image to obtain a first denoised output image 110. The second iteration (pass 2 140) uses the first denoised output image 110 as input and generates a second denoised image 130. The last iteration (pass T 160) produces a final denoised image 150 based on the second denoised image 130. While FIG. 1 illustrates 3 model passes, in practice, any number of model passes may be performed (e.g., T passes) to generate the output image.

FIG. 1 illustrates a first denoised image 110. First denoised image 110 is generated after pass 1 120 of a diffusion model. First denoised image 110 is provided as input to the diffusion model during a second pass (pass 2 140) of the diffusion model. In the second pass (pass 2 140), the second denoised image 130 is generated as output by denoising the first denoised image 110.

The second denoised image 130 becomes final denoised image 150 after being denoised by a diffusion transformer using a sequence of additional model passes to remove all (or almost all) of the noise in the image. Each model pass is associated with a successive timestep, such that after a set number of timesteps, the model generates the final denoised image 150. For example, the final denoised image 150 may be generated after a T-th pass (pass T 160) of the diffusion model.

More specifically, there may be an initial noisy input x₁ 112. Initial noisy input x₁ 112 may be noisy data (such as randomly generated noise) supplied to the model, which, after being processed by the model, generates new content (such as images or videos). This generation process utilizes a mapping relationship from noise to original data for which the diffusion model is previously trained.

Initial noisy input x₁ 112 may be provided to a trained diffusion transformer DiT unit 114, shown as having a single transformer block (though such a trained diffusion transformer DiT unit 114 may include a sequence of N diffusion transformer (DiT) blocks). The trained diffusion transformer DiT unit 114 may be trained using a forward diffusion process in which random noise (such as Gaussian noise) is gradually introduced into content (such as an image) and a reverse diffusion process which enables the trained diffusion transformer DiT unit 114 to reverse the diffusion to take noisy or random content and use it to generate new samples of content similar to the training data used in the forward diffusion process.

The trained diffusion transformer DiT unit 114 may include, as an example in the single transformer block, a self-attention layer 116 followed by a feedforward layer 118. The outputs of the self-attention layer 116 and the feedforward layer 118 are added together with other information in the single transformer block of the trained diffusion transformer DiT unit 114 at combination unit 122 and combination unit 124. Combination unit 124 generates the first denoised image 110 as the result of the first model pass (pass 1 120).

However, this is just an example of layers and other layers may be used in other use cases. Also, FIG. 1 illustrates the use of only one transformer block in a trained diffusion transformer DiT unit 114. In other examples, there may be multiple transformer blocks in a trained diffusion transformer DiT unit 114, each having their own internal layers.

The techniques presented herein apply to any diffusion transformer model with computationally intensive common/unitary components within the transformer block(s). For example, a diffusion transformer block might have two separate feedforward layers and a self-attention block layer. Another diffusion transformer block might have one feedforward layer, one self-attention layer, and one cross-attention layer.

First denoised image 110 corresponds in content to a first partially denoised input x₂ 132. Partially denoised input x₂ 132 may be provided to pass 2 140, where partially denoised input x₂ 132 is processed by a trained diffusion transformer that is similar in structure and operation to trained diffusion transformer DiT unit 114, but with different input. For example, pass 2 140 may take partially denoised input x₂ 132 and use a self-attention layer and a feedforward layer in pass 2 140, generating second denoised image 130 as the result of the second model pass, pass 2 140.

Again, other layers and/or blocks may be used in other cases. However, the trained diffusion transformer used in pass 2 140 and its constituent layers and/or blocks have the same structure as trained diffusion transformer DiT unit 114, as this allows comparison of constituent layers and/or blocks to comparable layers and/or blocks. Likewise, if multiple blocks are used in a given diffusion transformer, the model architecture stays the same.

Second denoised image 130 corresponds in content to a second partially denoised input x_{T} 152. Second partially denoised input x_{T} 152 is referred to as being associated with timestep T because it may take more than the three model passes shown in FIG. 1 to fully denoise an image by using a diffusion transformer. Second partially denoised input x_{T} 152 may be provided to a trained diffusion transformer having a single transformer block similar in structure and operation to that of trained diffusion transformer DiT unit 114.

Second partially denoised input X_{T} 152 may be provided to pass T 160, where second partially denoised input X_{T} 152 is processed by a trained diffusion transformer that is similar in structure and operation to trained diffusion transformer DiT unit 114, but with different input. For example, pass T 160 may take second partially denoised input X_{T} 152 and use a self-attention layer and a feedforward layer in pass T 160, generating final denoised image 150 as the result of the final model pass, pass T 160. The model used is the same model with the same weights, but there may be a concept of a timestep embedding passed into the model, which gives the model a general idea of how many passes of the model have elapsed so far (which is how the model can produce a different output from the previous timestep).

Again, other layers and/or blocks may be used in other cases. However, the trained diffusion transformer used in pass T 160 and its constituent layers and/or blocks have the same structure as trained diffusion transformer DiT unit 114, as this allows comparison of constituent layers and/or blocks to comparable layers and/or blocks. Likewise, if multiple blocks are used in a given diffusion transformer, the model architecture stays the same. Usually, these models run through multiple transformer blocks (each with its own weights) for a given timestep before the model produces an intermediate output.

FIG. 1 also shows label x_{N} 170. This label indicates that while only one transformer block is illustrated for trained diffusion transformer DiT unit 114 used in pass 1 120 (and the comparable trained diffusion transformers used in pass 2 140 and pass T 160) the model in FIG. 1, other models may include a plurality of transformer blocks and each of those blocks may have its own internal structure and layers. In some cases, such a plurality of transformer blocks may include a number of the same transformer blocks (i.e., the same types of layers and structures) and in other cases the transformer blocks may differ from one another.

FIG. 1 illustrates that diffusion models are configured to generate high quality images (such as final denoised image 150) from noisy data, such as an image comprising random noise, a noisy image (e.g., grainy image captured in low light or with high zoom), etc.

However, as illustrated in FIG. 1, the denoising may use several computation-intensive model passes (e.g., executions of DiT units 114 comprising N blocks) to generate final denoised image 150. Eliminating a portion of the computation while maintaining acceptable quality of output images reduces the computational cost of a diffusion model, such as the one with diffusion transformers illustrated in FIG. 1.

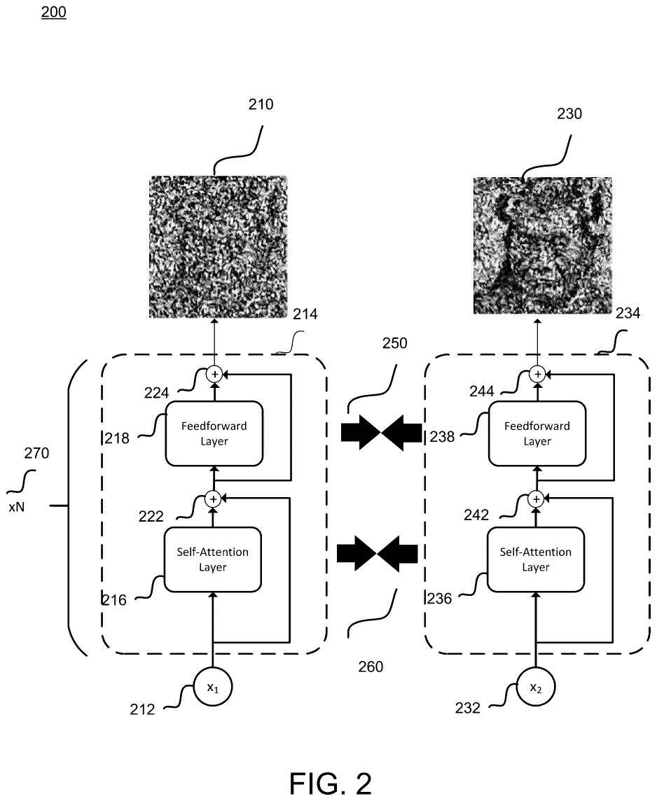

### FIG. 2—Similar Successive Passes of Diffusion Transformer

FIG. 2 is a diagram illustrating an example of successive passes processed by a diffusion transformer that are similar in layer output 200, in accordance with some implementations.

As seen in FIG. 2, a diffusion transformer (DiT) unit 214 may include a plurality of DiT blocks. A DiT block includes a self-attention layer 216, a feedforward layer 218, and combination units 222 and 224. These elements are similar to comparable elements set forth in FIG. 1.

FIG. 2 begins with initial noisy input x₁ 212. Initial noisy input x₁ 212 may be provided to a trained diffusion transformer DiT unit 214, wherein FIG. 2 shows trained diffusion transformer DiT unit 214 as having a single transformer block. Combination unit 222 combines the output of self-attention layer 216 with its input 212 (denoted as x₁). Output of combination unit 222 is provided as input to feedforward layer 218. Combination unit 224 combines the output of feedforward layer 218 and the output of combination unit 222. As illustrated in FIG. 2, a DiT unit 214 may include N DiT blocks arranged sequentially, where the output of a first block of the N DiT blocks being provided as input to a second DiT block of the N DiT blocks, and so on.

In FIG. 2, first denoised image 210 corresponds in content to intermediate noisy input x₂ 232. Intermediate noisy input x₂ 232 may be provided to a trained diffusion transformer DiT unit 234 illustrated as having a single transformer block. DiT unit 234 corresponds to DiT unit 214. The single transformer block of trained diffusion transformer DiT unit 234 may include a self-attention layer 236 followed by a feedforward layer 238. The outputs of the self-attention layer 236 and the feedforward layer 238 are added together with information from earlier in the single transformer block of trained diffusion transformer DiT unit 234 at combination unit 242 and combination unit 244. Combination unit 244 generates a second denoised image 230 as the result of the second model pass. As discussed, this is merely an example and there may be a plurality of transformer blocks, each having its own appropriate layers.

FIG. 2 illustrates arrows indicating a comparison 250 between respective outputs of the corresponding feedforward layers and a comparison 260 between the respective outputs of the corresponding self-attention layers in successive timesteps of execution of the diffusion model. Comparison 250 indicates that feedforward layer 218 and feedforward layer 238 have similar outputs to one another across timesteps. Comparison 260 indicates that self-attention layer 216 and self-attention layer 236 have similar outputs to one another across timesteps. In various situations, either or both types of layers in sequential timesteps may be similar (within a threshold value of each other) or there may be dissimilar outputs in the timesteps.

Based on comparison 250 and comparison 260, FIG. 2 illustrates a situation in which it is possible to reuse self-attention layer outputs and feedforward layer outputs without introducing error (or error below a threshold value) in the output of the diffusion model. FIG. 2 shows an example in which feedforward layer 218 and feedforward layer 238 are deemed similar to one another at comparison 250 and self-attention layer 216 and self-attention layer 236 also deemed similar to one another at comparison 260.

FIG. 2 also shows label x_{N} 270. This label indicates that while only one transformer block is illustrated for trained diffusion transformer DiT unit 214 and only one transformer block is illustrated for trained diffusion transformer DiT unit 234 in the model in FIG. 2, other models may include a plurality of transformer blocks and each of those blocks may have its own internal structure and layers.

However, the comparisons are to be carried out on a layer by layer and timestep by timestep basis. For example, it is entirely possible that output of a feedforward layer could be cached over several timesteps while a self-attention layer is not cached at all for several timesteps. Such caching is managed using individual layers' caching schedules.

Hence, layers of transformer blocks that output first denoised image 210 and the second denoised image 230 may be deemed similar enough that information obtained as output of layers in the diffusion transformer blocks for one timestep may be cached and used for the layers in the diffusion transformer blocks for the other timestep. Aspects of such caching are discussed further, herein.

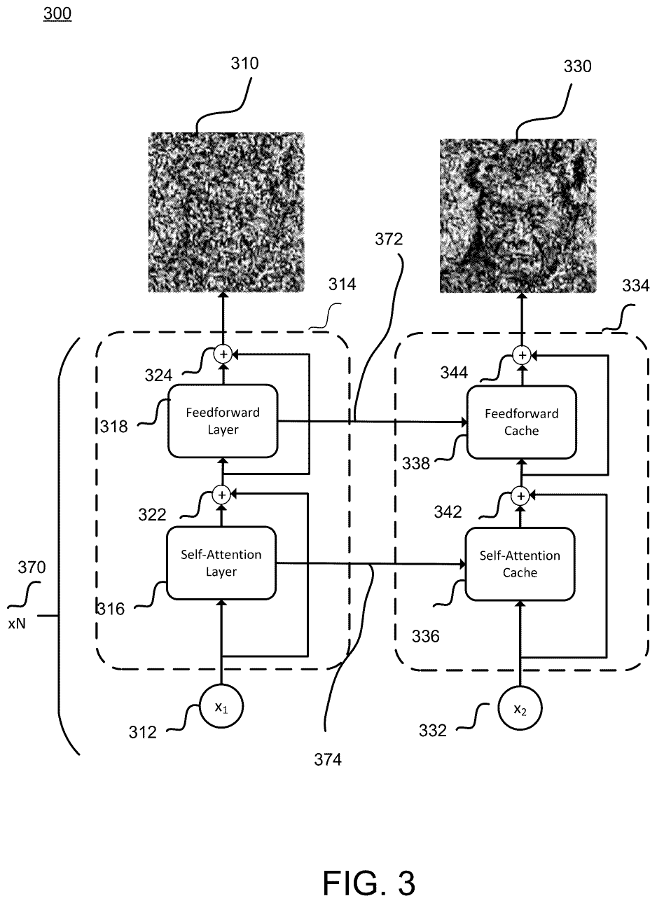

### FIG. 3—Reusing Information in Diffusion Transformer

FIG. 3 is a diagram illustrating an example of reusing information in a diffusion transformer by caching 300, in accordance with some implementations.

As seen in FIG. 3, a diffusion transformer (DiT) unit 314 may include a plurality of DiT blocks. A DiT block includes a self-attention layer 316, a feedforward layer 318, and combination units 322 and 324. These elements are similar to comparable elements set forth in FIG. 1.

Combination unit 322 combines the output of self-attention layer 316 with its input 312 (denoted as x₁). Output of combination unit 322 is provided as input to feedforward layer 318. Combination unit 324 combines the output of feedforward layer 218 and the output of combination unit 322. As illustrated in FIG. 3, a DiT unit 314 may include N DiT blocks arranged sequentially, where the output of a first block of the N DiT blocks being provided as input to a second DiT block of the N DiT blocks, and so on.

FIG. 3 begins with initial noisy input x₁ 312. Initial noisy input x₁ 312 may be provided to a trained diffusion transformer DiT unit 314, illustrated as having a single transformer block. The single transformer block of trained diffusion transformer DiT unit 314 may include a self-attention layer 316 followed by a feedforward layer 318. The outputs of the self-attention layer 316 and the feedforward layer 318 are added together with information from earlier in the single transformer block of trained diffusion transformer DiT unit 314 at combination unit 322 and combination unit 324. Combination unit 324 generates the first denoised image 310 as the result of the first model pass. As discussed, this is merely an example and there may be a plurality of transformer blocks in a diffusion transformer model, each having its own appropriate layers.

In FIG. 3, first denoised image 310 corresponds in content to intermediate noisy input x₂ 332. Intermediate noisy input x₂ 332 may be provided to a trained diffusion transformer DiT unit 334, shown as having a single transformer block. DiT unit 334 corresponds to DiT unit 314. The single transformer block of trained diffusion transformer DiT unit 334 may include a self-attention cache 336 followed by a feedforward cache 338. The self-attention cache 336 indicates that the layer of the block is not to be executed, and rather, outputs of the corresponding self-attention layer 316 from the previous timestep are to be used. Similarly, the feedforward cache 338 indicates that the layer of the block is not to be executed and the output of the corresponding feedforward layer 318 from the previous timestep are to be used as the output of feedforward cache 338. Again, this is merely an example and there may be a plurality of transformer blocks in a diffusion transformer model, each having its own appropriate layers. As noted previously, the L1 relative loss can also be used to calculate the error between the Nth and N+k-th layer (where k can be 1, 2, 3, 4, etc., subject to memory constraints) to determine how many layers to skip as part of the caching method.

However, this is only an example, and it may be possible to reuse information from self-attention layer 316 for self-attention cache 336 without reusing information for feedforward layer 318 (i.e., the feedforward layer 318 may not be suitable for caching at specific timestep).

The outputs of the self-attention cache 336 and the feedforward cache 338 are added together with information with respect to intermediate noisy input x₂ 332 from earlier in the single block of trained diffusion transformer DiT unit 334 at combination unit 342 and combination unit 344. Combination unit 344 generates a second denoised image 330 as the result of the second model pass. If some of the information used for the second model pass is cached, there may be a quality degradation. However, by setting a threshold a as discussed herein, it may be possible to manage the extent to which quality deteriorates while obtaining a meaningful performance increase.

FIG. 3 also shows label x_{N} 370. This label indicates that while only one transformer block is used in trained diffusion transformer DiT unit 314 and one transformer block is used in trained diffusion transformer DiT unit 334 as illustrated in the model in FIG. 3, other models may include a plurality of transformer blocks and each of those blocks may have its own internal structure and layers.

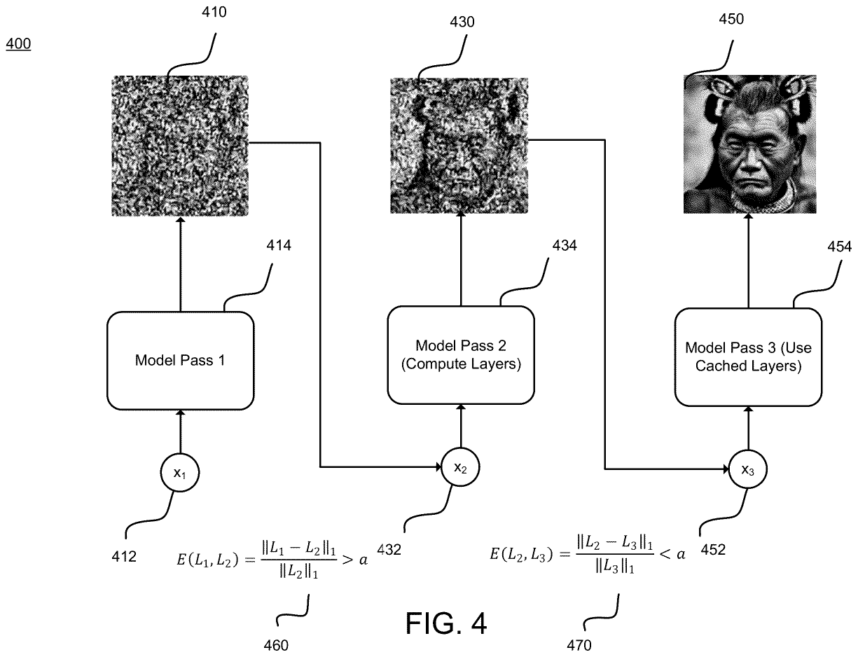

### FIG. 4—Managing Caching for Diffusion Transformer

FIG. 4 is a diagram illustrating an example of managing caching based on differences between outputs of successive model passes 400 (in calibration runs), in accordance with some implementations. FIG. 4 begins with initial noisy input x₁ 412. Initial noisy input x₁ 412 is provided to model pass 1 414. FIG. 4 assumes that the same model is used throughout and a calibration run has previously been performed to assess when executing model layers to obtain outputs is performed for all layers.

Model pass 1 414 generates denoised image 410 that corresponds to intermediate noisy input x₂ 432. Intermediate noisy input x₂ 432 is provided to model pass 2 434. Model pass 2 434 may determine whether to compute model layer outputs based on intermediate noisy input x₂ 432. Such a determination may be made by relying on a caching schedule, derived from a calibration process and error curves as discussed herein.

For example, to generate information for error curves, there may be a comparison 460 between outputs in model pass 1 414 (based on initial noisy input x₁ 412) and outputs for model pass 2 434 (based on intermediate noisy input x₂ 432) based on a heuristic. The heuristic may correspond to the relative L1 norm between outputs for two subsequent timesteps for the same layer, as compared to a user selected threshold a. For example, layer outputs may be compared to corresponding layers across timesteps.

For example, comparison 460 may use a heuristic defined by the equation

$$E ( {L}_{1} , {L}_{2} ) = \frac{{‖ {L}_{1} - {L}_{2} ‖}_{1}}{{‖ {L}_{2} ‖}_{1}} > a .$$

This defines the relative L1 norm between two subsequent timesteps for values produced for the same layer across timesteps, as compared to a user selected threshold a, for the first two timesteps. However, other heuristics establishing a difference between outputs of different layers may also be used.

Likewise, to generate information for error curves, there may be a comparison 470 using a similar heuristic defining a difference between model pass 2 434 (based on intermediate noisy input x₂ 432) and model pass 3 454 (based on second intermediate noisy input x₃ 452). For example, comparison 470 may be defined by the equation

$$E ( {L}_{2} , {L}_{3} ) = \frac{{‖ {L}_{2} - {L}_{3} ‖}_{1}}{{‖ {L}_{3} ‖}_{1}} < a .$$

This defines the relative L1 norm between two subsequent timesteps for the same layer, as compared to a user selected threshold a, for the second two timesteps. For example, layer outputs may be compared to corresponding layers across timesteps. However, other heuristics establishing a difference between outputs of different layers may also be used.

Thus, comparison 460 illustrates that the heuristic is greater than the threshold a and comparison 470 illustrates that the heuristic is less than the threshold a. Hence, in model pass 2 434, it is necessary to compute the layer outputs because the layer outputs from model pass 1 414 are sufficiently different from those of model pass 2 434 that the layer outputs are to be computed at model pass 434 and used to generate intermediate denoised image 430 (because the error exceeds the threshold a). Information about this situation is obtained from what is stored in the pre-generated caching schedule derived during the calibration process.

However, when using second intermediate noisy input x₃ 452 which corresponds to intermediate denoised image 430, comparison 470 illustrates that the heuristic is less than the threshold a. Accordingly, when performing model pass 3 454, it is possible to use cached values for the layer outputs for one or more layers in the model pass to generate final denoised image 450 (because the error is less than the threshold a).

FIG. 4 illustrates an example in which all of the layer output differences are greater than or less than a. However, as noted, error is tracked between individual layers, and it may be possible to cache a subset of layers while calculating information for other layers. Such caching and calculating is managed based on the pre-stored scheduling information, which is in turn based on error curves derived during calibration runs.

Here, a is a user selected threshold determined on evaluated performance based on generation metrics for the specific generation domain (FID for images, CLAP score for audio, etc.). This function decides whether a layer output is cached based on that threshold. The amount of layers to skip is based on computing multiple error curves based on skipping every n layers, and the highest n with error below the threshold is used as the skip length for the cached layer. An example of such error curves is illustrated for image blocks at FIG. 7A. These error curves are then used to derive a caching schedule (examples of which are illustrated at FIGS. 7B-7C), which can then be applied at inference time.

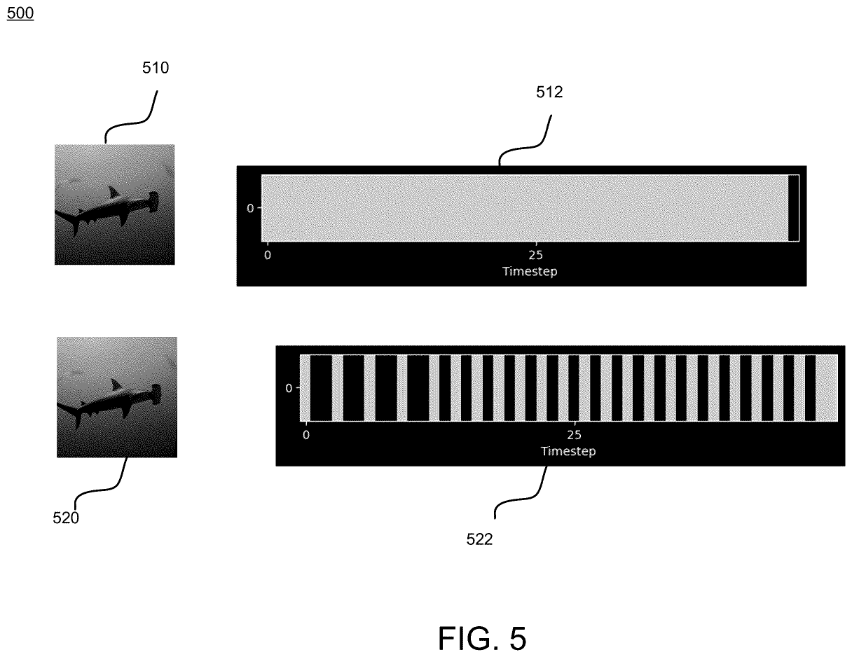

FIG. 5—Examples of Diffusion Transformer Output without and with Caching (with Corresponding Caching Schedules)

FIG. 5 is a diagram illustrating an example of diffusion transformer output without caching and with error-guided adaptive caching 500, in accordance with some implementations. FIG. 5 illustrates an image of a hammerhead shark generated without caching 510 and an image of a hammerhead shark generated with caching 520. While these images are not identical, they are visually very similar and the image of a hammerhead shark generated with caching 520 preserves much of the visual quality of the image of a hammerhead shark generated without caching 510 while eliminating significant amounts of computation.

Schedule 512 corresponds to the image of a hammerhead shark generated without caching 510 (where layers in all blocks are executed during each timestep in a run of the diffusion model) and schedule 522 corresponds to the image of a hammerhead shark generated with caching 520 (where one or more layers in one or more blocks of the diffusion transformer of the diffusion model are skipped and cached values of corresponding layer outputs from a preceding timestep during the execution of the model are reused are layer outputs in the current timestep). In schedule 512 and schedule 522, gray areas correspond to layers that are executed at different timesteps.

In schedule 512, every timestep area is computed (except for the final layer) because no caching or reuse of layer data occurs. By contrast, in schedule 522, many of the timestep areas are black, indicating that they are not to be computed and can operate based on cached layer output information for the diffusion models in those layers. In schedule 522, about 60% of compute-intensive layers may be skipped. The given example is a possible improved (not necessarily optimal) schedule.

As illustrated in schedule 522, for every gray area there is a black area of varying width, indicating that for those layers, computation is not considered necessary and cached layer output information may be used for self-attention layers and feedforward layers. Also, in schedule 522 it is illustrated that more skipping of layers is feasible at early timesteps.

The error in diffusion is greater at later timesteps in this example, and hence fewer layers can be skipped before computation is necessary again. In other examples, the error may be greater at early and late timesteps, and the ability to cache layers may be affected, accordingly.

FIG. 5 may correspond to an example in which the layers are self-attention and feedforward layers in a single transformer block, and in which all layers are either cached or calculated in each timestep. As noted, in other implementations, the model may include different transformer blocks having different layers and the individual layers may have their own caching schedules.

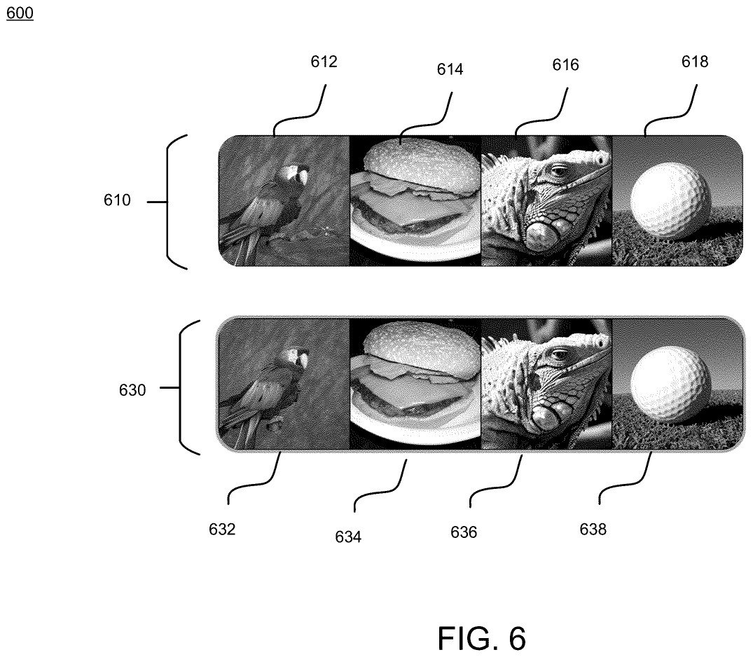

FIG. 6—Examples of Diffusion Transformer Output without and with Caching

FIG. 6 is a diagram illustrating examples of various outputs of a diffusion transformer used to generate images, with and without error-guided adaptive caching 600, in accordance with some implementations. For example, there may be outputs of a baseline diffusion transformer image generation model 610 and outputs of a diffusion transformer image generation model using the adaptive caching as proposed herein 630.

For example, FIG. 6 illustrates an image of a parrot generated with baseline techniques 612 and a parrot generated with caching techniques 632. FIG. 6 also illustrates an image of a cheeseburger generated with baseline techniques 614 and a cheeseburger generated with caching techniques 634. FIG. 6 also illustrates an image of a reptile generated with baseline techniques 616 and a reptile generated with caching techniques 636. FIG. 6 also illustrates an image of a golf ball generated with baseline techniques 618 and a golf ball generated with caching techniques 638.

FIG. 6 illustrates that each image generated with baseline techniques is of similar visual quality to its counterpart generated with caching techniques as described herein. However, there may be a substantial improvement in generation time. As an example, one or more images may use 6.0 seconds of generation time if no caching is used.

By comparison, the same one or more images may use 2.8 seconds of generation time if no caching is used. The amount of time savings may vary based on particular use cases. Overall, relative acceleration for image generation techniques may provide a relative acceleration of 1.2× to 1.3×. In addition, there may be a significant acceleration in other applications of diffusion models (such as diffusion transformers) such as a video generation model or voice translation.

FIG. 6 may correspond to an example in which the layers are self-attention and feedforward layers in a single transformer block, and in which all layers are either cached or calculated in each timestep. As noted, in other implementations, the model may include different transformer blocks having different layers and the individual layers may have their own caching schedules.

### FIG. 7A—Graph of Error Value and Timesteps

FIG. 7A is a graph illustrating relationships between error values and timesteps based on skipping certain numbers of blocks 700, in accordance with some implementations. The graph 702 illustrates an error introduced by skipping N blocks. For example, the x-axis 704 of graph 702 corresponds to a timestep of the diffusion transformer. For example, the diffusion transformer may use 35 model passes to fully generate inference output, such as an image, from input such as random noise.

The y-axis 706 of graph 702 corresponds to an L1 relative error. Graph 702 illustrates three error curves, error curve 708, error curve 710, and error curve 712. Error curve 708 corresponds to the amount of error introduced by skipping 1 block at various timesteps. Error curve 710 corresponds to the amount of error introduced by skipping 2 blocks at various timesteps. Error curve 712 corresponds to the amount of error introduced by skipping 3 blocks at various timesteps.

FIG. 7A illustrates that for each error curve, there is a high error at the beginning and end but low error in the middle (in terms of progression of the diffusion model execution over timesteps). Additionally, as more blocks are skipped, the more error occurs. It makes sense to do a progression in which initially a low number of blocks is skipped, then a greater number is skipped, then a lower number is skipped again. To do so, it may be appropriate to use a greedy strategy to take the maximum cache steps possible such that the error is below a threshold a. For example, if the threshold is 0.15 (as illustrated in the curves shown in FIG. 7A), the schedule looks like 1->2->3->2->1.

For example, initially the strategy may only skip one block at a time without exceeding the error threshold, but the strategy may skip two blocks at a time and then three blocks at a time as the error caused by skipping more blocks decreases as timesteps 15-20 are reached. At this point, the error introduced by skipping a large number of blocks increases again as timestep 35 is approached, so it is possible to skip two blocks at a time and then one block at a time without exceeding the error threshold. As noted, the L1 relative loss can also be used to calculate the error between the Nth and N+k-th layer (where k can be 1, 2, 3, 4, etc., subject to memory constraints) to determine how many layers to skip as part of the caching method.

For example, there may be a set of graphs illustrating relationships between error values and timesteps based on skipping certain numbers of blocks in a video generation use case, in accordance with some implementations. For example, in video generation, there may be a graph of calibration for spatial self-attention, a graph of calibration for a spatial feedforward network, a graph of calibration for spatial cross attention, a graph of calibration for temporal self-attention, a graph of calibration for a temporal feedforward network, and a graph of calibration for temporal cross attention. Each graph may be used in combination with a threshold value to establish an appropriate caching schedule that governs caching for each layer.

In audio generation, there may be different calibration graphs. For example, there may be a graph of calibration for attention caching, a graph of calibration for multi-layer perceptron (MLP) caching, and a graph of calibration for cross-attention caching. Each graph may be used in combination with a threshold value to establish an appropriate caching schedule that governs caching for each layer.

While there may differences between the various calibration graphs, there are certain common factors. Overall, for calibration graphs for image, video, and audio generation, error based on caching becomes greater as more blocks are skipped. Also, generally the most errors tend to occur at the beginning and end of the denoising for video and hence this guides how caching is to be performed. However, there may be differences in shape between graphs, and this will affect the generated caching schedule.

### FIG. 7B—Data Structure

FIG. 7B is a data structure that defines skipping certain numbers of blocks in a video generation use case, in accordance with some implementations. FIG. 7B shows JavaScript Object Notation (JSON) markup (though in other implementations, other markup languages or other ways to represent the caching schedule could be used). The JSON markup includes labels that indicate which layer is being associated with a caching schedule, followed by the caching schedule itself, which is a sequence of numbers such that 1 indicates that caching is not enabled for that layer at that timestep (meaning the layer is executed at that timestep) and a 0 indicating that that particular layer may be skipped at that timestep (with the output of the corresponding layer from a previous timestep being reused as the output of the particular layer). The JSON may also include information about the acceleration factor, and layers skipped and computed. However, such information is optional and the JSON may only include labels defining the caching schedule.

### FIG. 7C—Graph of Error Value and Timesteps

FIG. 7C is additional markup language defining skipping certain numbers of blocks in an audio generation use case, in accordance with some implementations. FIG. 7C shows JavaScript Object Notation (JSON) markup (though in other implementations, other markup languages or other ways to represent the caching schedule could be used). The JSON markup includes labels that indicate which layer is being associated with a caching schedule, followed by the caching schedule itself, which is a sequence of numbers such that 1 indicates that caching is not enabled for that layer at that timestep (meaning the layer is executed at that timestep) and a 0 indicating that that particular layer may be skipped at that timestep (with the output of the corresponding layer from a previous timestep being reused as the output of the particular layer). The JSON may also include information about the acceleration factor, and layers skipped and computed. However, such information is optional and the JSON may only include labels defining the caching schedule.

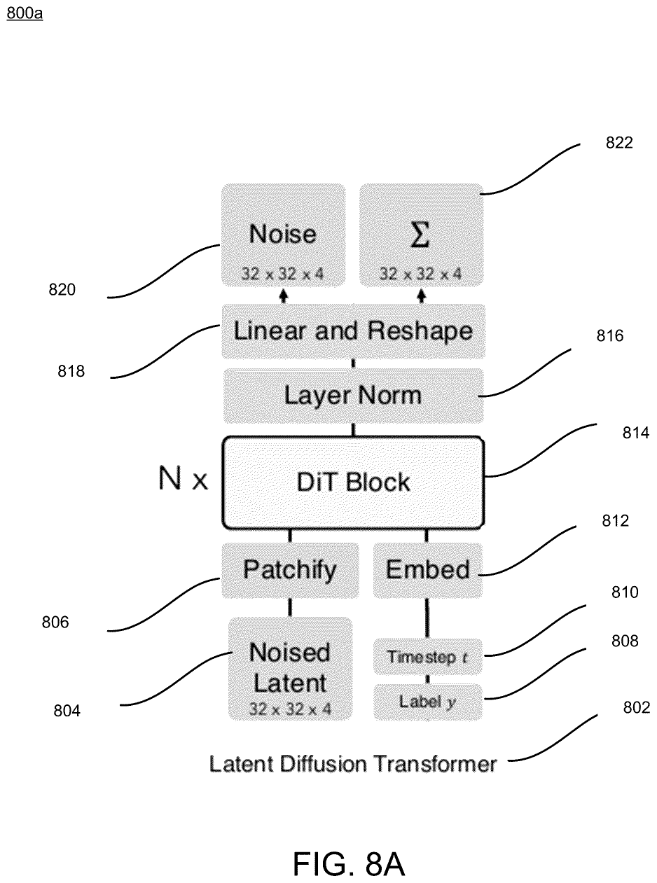

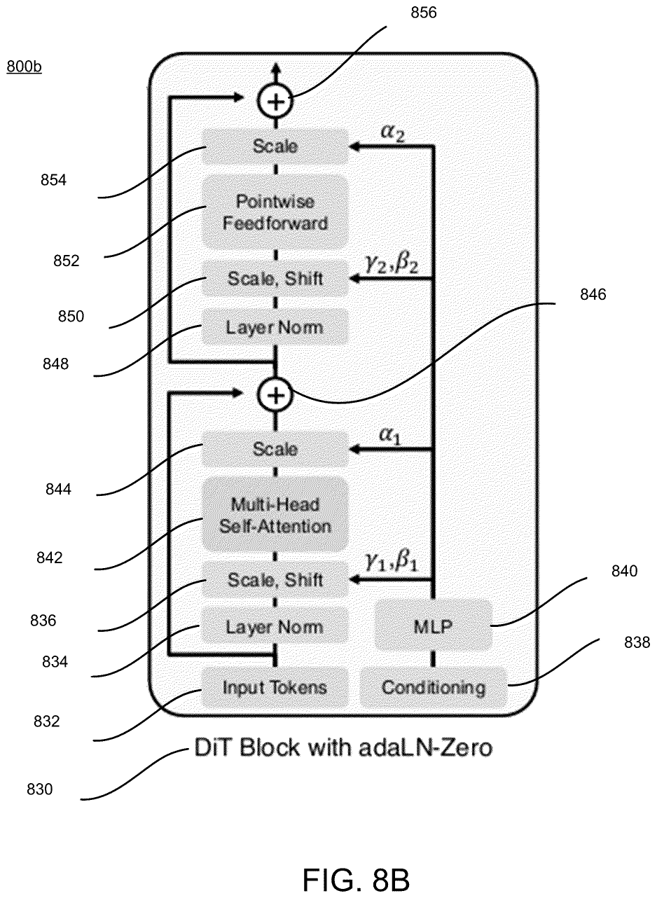

### FIG. 8A—Structure of Diffusion Transformer

FIG. 8A is a diagram illustrating the structure of a diffusion transformer model 800a, in accordance with some implementations. There may be a latent diffusion transformer model 802 illustrated in FIG. 8A. The latent diffusion transformer 802 may operate based on a noised latent 804 corresponding to a 32×32×4 image. The noised latent 804 is provided to a patchify operation 806.

The patchify operation 806 converts the spatial input into T tokens, each of dimension d, by linearly embedding each patch in the input. Another initial stage may include performing an embed operation 812 based on information such as label information y 808 and timestep information t at 810. This information is provided to a number N of diffusion transformer (DiT) blocks 814. An example structure of an individual DiT block is illustrated in FIG. 8B.

After the final DiT block, it is appropriate to decode the sequence of image tokens into an output noise prediction 820 and an output diagonal covariance prediction 822. Both of these outputs have a shape equal to that of the original spatial input (32×32×4). A linear decoder may be used to do this.

For example, there is applied a layer norm 816 (which may be adaptive if using adaLN) used to linearly decode each token into a p×p×2C tensor, where C is the number of channels in the spatial input to the DiT. Finally, the reshape portion of a linear and reshape unit 818 rearranges the decoded tokens into their original spatial layout to get the predicted output noise predicted 820 and the predicted output diagonal covariance prediction 822.

### FIG. 8B—Structure of Diffusion Transformer Block

FIG. 8B is a diagram illustrating the structure of a diffusion transformer block 800b, in accordance with some implementations. FIG. 8B illustrates a diffusion transformer (DiT) block with adaptive layer norm (adaLN)-Zero 830 as an example. Such an architecture may be used for performance advantages.

This approach involves replacing alternative layer norm layers in transformer blocks with adaptive layer norm (adaLN). Rather than directly being trained to identify dimension-wise scale and shift parameters γ and β, this technique regresses them from the sum of certain embedding vectors. The “zero” aspect of adaptive layer norm (adaLN)-Zero 830 refers to initially initializing each residual block as the identity function, which may accelerate large-scale training. In other implementations, a DiTBlock with Cross-Attention or a DiTBlock with in-Context Conditioning may be used.

The diffusion transformer (DiT) block with adaLN-Zero 830 begins by receiving input tokens 832. The input tokens 832 are processed using a layer norm 834, scale and shift 836, and multi-head self-attention 842, and another scale 844 operation. There is also conditioning information 838 processed through a multi-layer perceptron (MLP) 840 combined with layer norm 834 information, where the MLP has an effect on the scale and shift 836 and the scale 844 operations. The result of the scale 844 operation is combined with the input tokens 832 at an addition unit 846.

The results generated by addition unit 846 are fed into another sequence of units, including a layer norm 848, scale and shift 850, and pointwise feedforward 852, and another scale 854 operation. These operations are also based on information from the MLP 840 provided at scale and shift 850 and scale 854. The result of the scale 854 operation is combined with the output of addition unit 846 at an addition unit 856. The output of addition unit 856 is then provided to then next DiT block (or for post-processing operations if the current DiT block is a final DiT block).

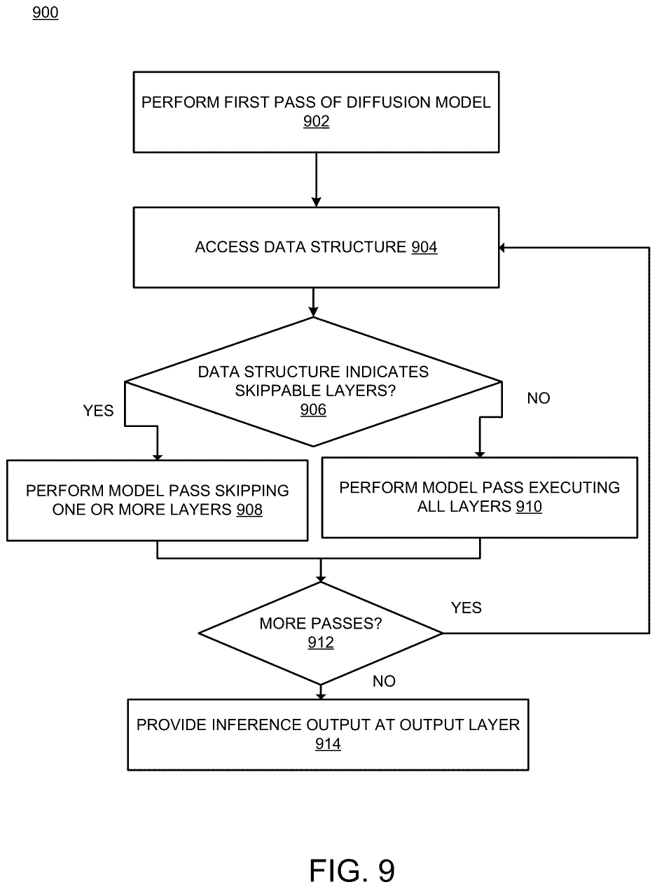

### FIG. 9—Providing Error-Guided Adaptive Caching for Diffusion Transformers

FIG. 9 illustrates a flowchart of an example computer-implemented method 900 to provide error-guided adaptive caching to diffusion transformers, in accordance with some implementations. Method 900 may begin at block 902.

At block 902, a first pass of a diffusion model may be performed. For example, the diffusion model may use a trained diffusion transformer model. The trained diffusion transformer model may include one or more transformer blocks, each transformer block including one or more layers (such as feedforward layers, self-attention layers, cross-attention layers, other computation-intensive layers, and various combinations thereof). Such a diffusion model begins with noisy input, where the noisy input is progressively denoised in an iterative fashion over multiple timesteps by the diffusion model to start with noise and generate corresponding output.

The first pass of the diffusion model involves calculating values for the diffusion model because there is no previous timestep to rely upon for cached information. Specifically, these values are values produced by layers as layer output within the one or more transformer blocks in the trained diffusion transformer model.

Prior to block 902, the diffusion model is trained using a forward diffusion process over a set number of timesteps and a reverse diffusion process to have the ability to reverse the noising process and generate output without noise after completing reverse diffusion for the same number of timesteps. Block 902 may be followed by block 904.

At block 904, a data structure is accessed to determine how to implement a subsequent pass of the diffusion model. Block 904 continues for as many timesteps as is necessary to fully complete reverse diffusion and remove all (or almost all) of the noise from the output by causing the output to resemble the training data used for the diffusion model. For example, the number of reverse diffusion timesteps corresponds to the number of forward diffusion timesteps used when originally training the diffusion model.

Specifically, the data structure may be a caching schedule that includes information about whether it is appropriate to reuse preceding information in a diffusion model pass for one or more blocks in the diffusion model (which may be a diffusion transformer), where the blocks each have one or layers (for example, one block may have a self-attention layer and a feedforward layer).

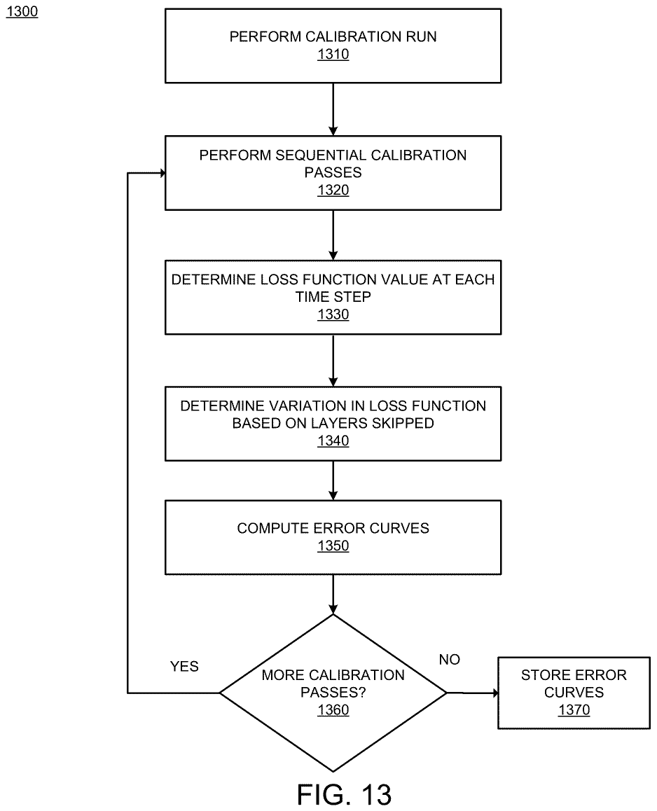

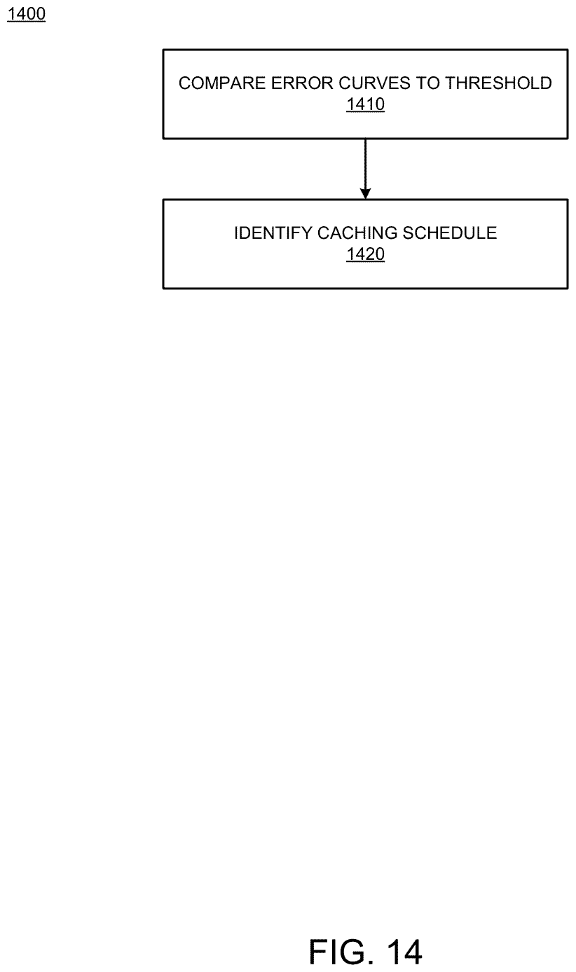

The data structure may indicate about whether reusing the layer output information is appropriate based on calibration passes and error curves, discussed further at FIG. 13 and FIG. 14. For example, the data structure may be a caching schedule, as discussed and illustrated in FIG. 7B and FIG. 7C. Block 904 may be followed by block 906.

At block 906, it is determined whether the data structure indicates that layers are skippable. The data structure does so based on an amount of error introduced into the model pass by reusing output layer information from the previous layer for the current layer for corresponding layers within blocks of the transformer. If so, block 906 is followed by block 908. If not, block 906 is followed by block 910.

At block 908, a model pass is performed based on skipping one or more layers from preceding values. Alternatively put, it is possible to use cached values for the diffusion model pass rather than involving the resource-intensive computation at that step. The cached values may include information output from the immediately preceding pass by accessing respective layer output values for the relevant layer(s) in each block of the plurality of blocks from the immediately preceding pass. An aspect of such reuse is that a computational cost associated with accessing the respective layer output values is lower than the computational cost otherwise is to actually execute the blocks (or a subset of layers contained within).

Because the data structure indicated that executing was unnecessary at block 906, the error introduced by omitting computation is known to satisfy a threshold, meaning that the user-set threshold acts as an upper bound on any error introduced by using caching for layers used in that timestep. Block 908 may be followed by block 912.

At block 910, a model pass is performed based on executing all layers at that model pass. Based on the determination from block 906, caching results in an unacceptable quality degradation if output from a layer at the previous timestep is reused in the next timestep (based on the schedule produced from the comparison of the error between layers, as detailed in FIG. 13 and FIG. 14).

Hence, for the current timestep corresponding to the performance of block 910, the self-attention and feedforward information for the relevant layer is newly computed based on corresponding pass output from the immediately preceding pass when performing the model pass for the current timestep because the caching schedule indicates that such computation is necessary. Block 910 may be followed by block 912.

At block 912, it is determined if more passes are necessary. If so, block 912 is followed by block 904, so that another pass of the diffusion model may be performed (e.g., to continue the denoising). For example, the model may be associated during training with a set number of timesteps, such that the number of timesteps corresponds to the number of timesteps used in the forward and reverse diffusion processes to train the diffusion transformer. If not, block 912 is followed by block 914.

At block 914, the inference output is provided at an output layer. If the diffusion model is an image generation diffusion model, the inference output is the generated image. However, if the diffusion model is a video generation diffusion model, the inference output is generated video.

Alternatively, the diffusion model may output audio, such as translated speech (where the diffusion model transforms speech in an input language, such as French, into an equivalent speech in an output language, such as English). Such an output shares characteristics of the training data on which the diffusion transformer was originally trained.

Due to the caching, quality metrics associated with the output may be slightly slower than those that would be associated with a diffusion transformer process without caching. However, control of the caching threshold a allows for a manageable about of quality degradation while still increasing inference speed.

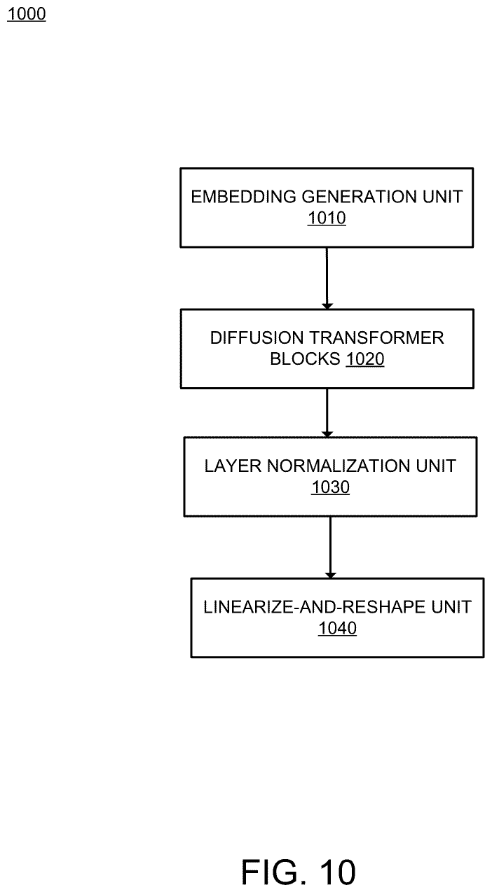

### FIG. 10—Sequence of Units in a Diffusion Model

FIG. 10 illustrates a sequence of units in a diffusion model 1000, in accordance with some implementations. An initial unit may be an embedding generation unit 1010. The embedding generation unit 1010 may take an initial input, such as a noisy image, and transform the input so that the input has the form of suitable tokens which can be processed using a diffusion model (e.g., a diffusion transformer). Accordingly, the embedding generation unit 1010 may be followed by diffusion transformer blocks 1020 that receives the tokens.

There may be N diffusion transformer blocks 1020 that form a sequence that denoises the tokens on each model pass. As an example, presented earlier, there may be a single diffusion transformer block in the model, such that the diffusion transformer block 1020 includes a self-attention layer and a feedforward layer. However, the diffusion transformer blocks 1020 may also include different layers and may differ from one another.

As discussed, based on the characteristics of a calibration run, the diffusion transformer blocks 1020 may compute information for the layers or may reuse and/or cache output information for the layers to reuse the layer information where reusing layer output information does not introduce too much error into the diffusion-based denoising process. Such caching occurs by identifying error curves during calibration (where the calibration establishes how much error various amounts of skipping leads to) and then establishes an appropriate caching schedule accordingly, where the caching schedule can be used to lookup, during inference, whether a given layer can be skipped for a given timestep.

The diffusion transformer blocks 1020 may be followed by a layer normalization unit 1030. The layer normalization unit 1030 may process the tokens generated by the diffusion transformer blocks 1020 after a given model pass. The layer normalization unit 1030 ensures that the inputs have a consistent distribution and reduces the internal covariate shift problem that can occur during training. The layer normalization unit 1030 may be followed by a linearize-and-reshape unit 1040.

The linearize-and-reshape unit 1040 may act as a linear decoder to take the output of the layer normalization unit 1030, decode the tokens into tensors, and rearrange the decoded tokens into an initial spatial layout to get predicted noise and covariance as outputs of the current model pass. For example, these units illustrated in FIG. 10 are simplified versions corresponding to some of the elements presented in FIG. 8A.

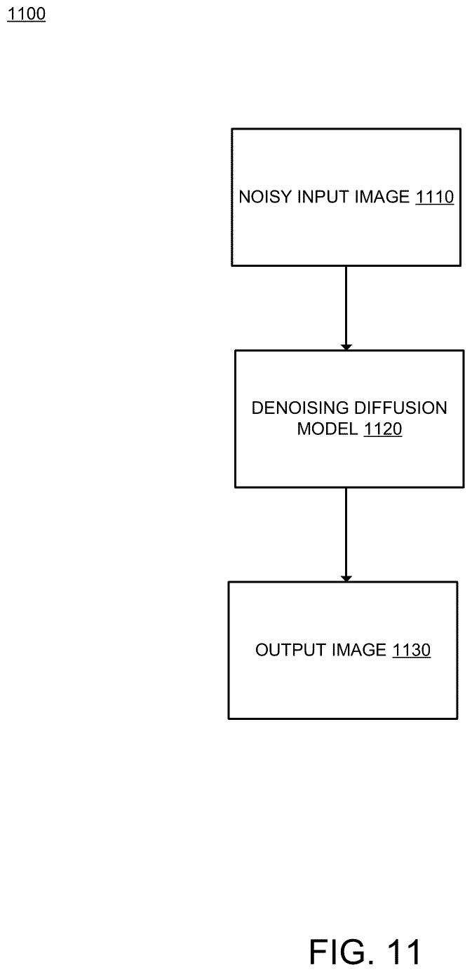

### FIG. 11—Sequence of Processing an Image Using a Diffusion Model

FIG. 11 illustrates a sequence of stages in processing where the diffusion model handles an image 1100, in accordance with some implementations. The process of FIG. 11 begins with a noisy input image 1110. The noisy input image 1110 is provided to a denoising diffusion model 1120. The denoising diffusion model 1120 provides an output image 1130. The denoising diffusion model 1120 does so by taking noisy input image 1110 and iteratively removing noise from the noisy input image 1110 by performing multiple passes on the image using the denoising diffusion model 1120.

While usually the denoising diffusion model 1120 calculates layer information (such as, for example, self-attention layer and feedforward layer information in blocks where the denoising diffusion model 1120 may use a diffusion transformer block including such example layers) some implementations as described herein provide ways to reuse and/or cache information for specific layers between successive timesteps, thereby decreasing the amount of time and computing resources necessary to take the noisy input image 1110 and provide output image 1130.

Such reuse and/or caching may decrease the quality of the output image 1130, but a user-set threshold that manages how caching occurs may control the quality degradation issues. In particular, using calibration as a warm-up phase prior to actual inference allows for the establishment of error curves that characterize various aspects of skipping layers by caching and establishing how many layers can be skipped and at what parts of the inference process (i.e., which timestep). Another way to do the calibration would be to perform calibration and share results of the calibration online with other users of the model, so other users can use precomputed cache schedules with known quality/performance tradeoffs. Such an approach may provide an alternative to an approach in which calibration occurs every time a model is launched.

While FIG. 11 illustrates a data progression for a single image, similar approaches are applicable for video as a succession of generated images (as well as associated audio).

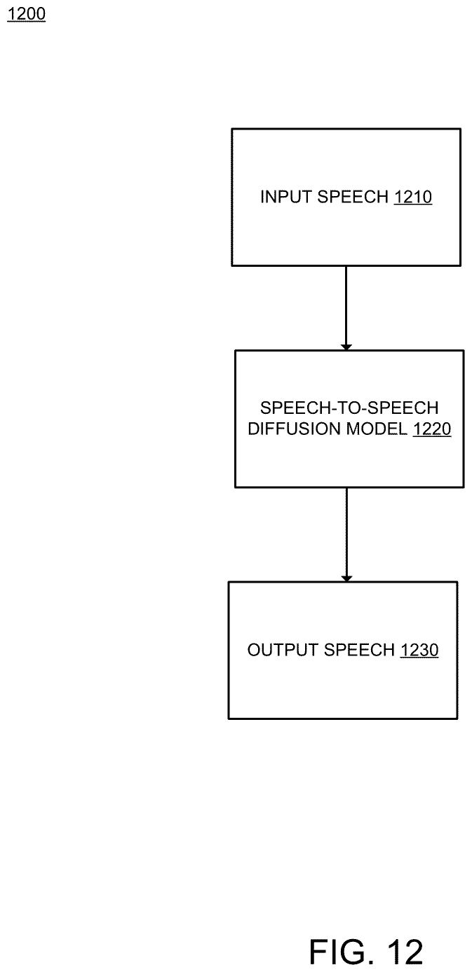

### FIG. 12—Sequence of Processing Speech Using a Diffusion Model

FIG. 12 illustrates a sequence of stages in processing where the diffusion model handles speech 1200, in accordance with some implementations. The process of FIG. 12 begins with an input speech 1210. The input speech 1210 is provided to a speech-to-speech diffusion model 1220. The speech-to-speech diffusion model 1220 provides an output speech 1230. The speech-to-speech diffusion model 1220 does so by taking the input speech 1210 and iteratively removing noise from the input speech 1210 by performing multiple passes on the speech using the speech-to-speech diffusion model 1220.

While usually the speech-to-speech diffusion model 1220 calculates layer information (such as self-attention layer and feedforward layer information in blocks where the speech-to-speech diffusion model 1220 may use a diffusion transformer architecture) some implementations as described herein provide ways to reuse and/or cache information for layers between successive timesteps, thereby decreasing the amount of time and computing resources necessary to take the input speech 1210 and provide output speech 1230.

Such reuse and/or caching may decrease the quality of the output speech 1230, but a user-set threshold that manages how caching occurs may control the quality degradation issues. In particular, using calibration as a warm-up phase prior to actual inference allows for the establishment of error curves that characterize various aspects of skipping layers by caching and establishing how many layers can be skipped and at what parts of the inference process (i.e., which timestep).

### FIG. 13—Performing Calibration

FIG. 13 illustrates a flowchart of a method 1300 to perform a calibration run and use the calibration run as the basis of determining error curves, in accordance with some implementations. Method 1300 may begin at block 1310. It may be possible to perform more than one calibration run. The calibration run(s) may be performed prior to using the diffusion model (e.g., in actual production and/or use), and the diffusion model may be updated based on subsequent calibration run(s).

For example, the calibration run(s) act as a warm-up or beta phase (or configuration phase) that takes a pre-trained diffusion transformer model and observes characteristics of its operation in order to ascertain which caching results in various types of performance degradation to allow the caching to adapt to characteristics of the diffusion transformer model to cache where possible without introducing too much error.

At block 1320, a plurality of sequential calibration passes of the diffusion model are performed by executing the plurality of blocks in the diffusion model to obtain relative calibration pass output, wherein each successive calibration pass uses a previous calibration pass output as input. Because the information about the previous calibration pass out is used to establish error information, it may be necessary to begin with an initial calibration pass as a standard for comparison. Block 1320 may be followed by block 1330.

At block 1330, a value of a loss function (E (L₁, L₂)) is determined based on a comparison of the calibration pass output for each pass with the calibration pass output of an immediately preceding pass. For example, the loss function may be obtained based on a heuristic, such that the heuristic can be calculated as the relative L1 norm between the same layer output in two subsequent timesteps. However, other heuristics may also be used that establish how output values change between layers.

When calculating the value of the loss function, the loss function is to be calculated between successive values of the output of the same layer. This calculation is more meaningful than calculating a loss function for entire blocks or entire transformers because it is based on outputs for the same layer, and it also allows different individual layers to provide their own information about layer changes. Block 1330 may be followed by block 1340.

At block 1340, it is determined how the value of the loss function varies based on the number of layers skipped. For example, there may be a user-set value of a threshold (such as threshold a, as discussed above), and if the value of the loss function is higher than that value, then the loss function does not satisfy the threshold (there is too much error) and if the value of the loss function is less than that value, then the loss function satisfies the threshold (the error is manageable). Block 1340 may be followed by block 1350.

At block 1350, the error curves are computed. The values for each layer are gathered and associated with error produced by introducing numbers of skips. For example, if it takes 50 passes to produce an image, the error curves would store the amount of introduced error (which is identified over time from the sequential calibration passes) in association with the model layers (for the relevant blocks) and the amount of skip.

For example, there might be an amount of error introduced at each timestep by introducing one, two, or three skips for a self-attention layer or a feedforward layer. A number of skips to generate error curves for may be based on available memory. Once the number of skips consistently generates high error (e.g., five to seven skips) it may no longer be useful to record error curves for that number of skips for that layer. Block 1350 may be followed by block 1360.

At block 1360, it is determined if more calibration passes are necessary. For example, calibration may occur for a set number of passes and/or may continue until additional calibration runs do not affect the results of the calibration. If so, block 1360 is followed by block 1320 and another calibration pass is begun. If not, block 1360 is followed by block 1370.

At block 1370, the error curves are stored for use in scheduling in inference.

### FIG. 14—Computing Error Curves and Selecting Thresholds

FIG. 14 illustrates a flowchart of a method 1400 to compare error curves to a threshold and identify a caching schedule accordingly, in accordance with some implementations. Method 1400 may begin at block 1410.

At block 1410, error curves associated with output error of the diffusion model with respective test caching strategies (e.g., those generated in FIG. 13 from the calibration passes, such that a caching strategy refers to a number of skips) are computed. Examples of such curves are illustrated in FIG. 7A.

For example, there may be a calibration pass performed based on trial inferences involving skipping a number n of timesteps after calculating layer output values at each timestep. For example, finding the error curves includes determining an L1 relative error introduced by skipping one timestep, two timesteps, three timesteps, etc.

The number of error curves varies based on a specific use case. The amount of error introduced increases along with the number of timesteps skipped for a given timestep. For example, at a 15^{th} timestep, skipping one timestep may cause an L1 relative error of 0.05, skipping two timesteps may cause an L1 relative error of 0.1, and skipping three timesteps may cause an L1 relative error of 0.15. Block 1410 may be followed by block 1420.

At block 1410, the error curves are also compared to a value of the threshold that is selected by a user. For example, the threshold may be selected such that the error caused by skipping timesteps does not cause the introduced L1 relative error to exceed a threshold a. Thus, it is possible to select the threshold from the error curves by observing how much skipping can occur without exceeding the threshold.

For example, as threshold a increases, the curves indicate that it is possible to skip more and more computation without causing too much quality degradation and the threshold may be selected to balance computation acceleration with quality degradation.

At block 1420, a caching schedule is identified for each layer. For example, there may be an error curve for each layer of one diffusion transformer block in a diffusion transformer model, where one layer is a feedforward layer and the other layer is a self-attention layer. However, this is only an example and there may be more than one diffusion transformer block in the diffusion transformer model and each diffusion transformer block may have different layer structures.

For example, to store a caching schedule, each layer in each block may be associated with a caching schedule in a markup language document (such as JSON). The markup language may specify, for each layer (in each block) whether the cached version of that layer is to be used at a given timestep or if a calculated version is to be calculated. The markup language may also specify characteristics and/or metadata of the caching (how many skips occur for a layer, how many computations occur for a layer, how much acceleration occurs, etc.).

Thus, in the method of FIG. 9, when the data structure is checked at block 906, the data structure (i.e., the caching schedule) indicates that cached values may be used for the blocks in that model pass, because using cached values does not introduce too much error into the diffusion model, as illustrated by the calibration pass(es).

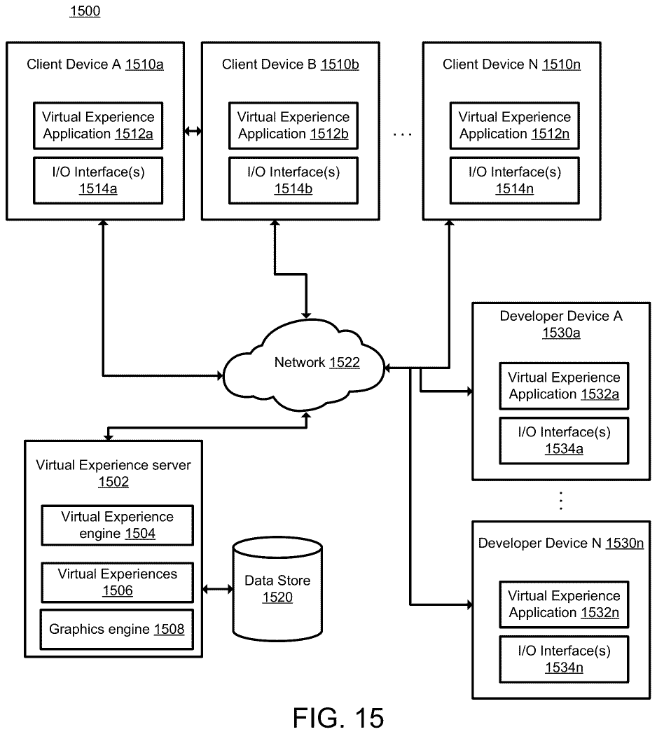

### FIG. 15—System Architecture

FIG. 15 is a diagram of an example system architecture 1500 that allows for adaptive error-guided caching for a diffusion transformer, in accordance with some implementations. FIG. 15 and the other figures use like reference numerals to identify similar elements. A letter after a reference numeral, such as “1510,” indicates that the text refers specifically to the element having that particular reference numeral. A reference numeral in the text without a following letter, such as “1510,” refers to any or all of the elements in the figures bearing that reference numeral (e.g., “1510” in the text refers to reference numerals “1510a,” “1510b,” and/or “1510n” in the figures).

The system architecture 1500 (also referred to as “system” herein) includes online virtual experience server 1502, data store 1520, client devices 1510a, 1510b, and 1510n (generally referred to as “client device(s) 1510” herein), and developer devices 1530a and 1530n (generally referred to as “developer device(s) 1530” herein). Virtual experience server 1502, data store 1520, client devices 1510, and developer devices 1530 are coupled via network 1522. In some implementations, client devices(s) 1510 and developer device(s) 1530 may refer to the same or same type of device.

Online virtual experience server 1502 can include, among other things, a virtual experience engine 1504, one or more virtual experiences 1506, and graphics engine 1508. In some implementations, the graphics engine 1508 may be a system, application, or module that permits the online virtual experience server 1502 to provide graphics and animation capability. In some implementations, the graphics engine 1508 and/or virtual experience engine 1504 may perform one or more of the operations described below in connection with the flowcharts shown in FIGS. 9 and 13-14. A client device 1510 can include a virtual experience application 1512, and input/output (I/O) interfaces 1514 (e.g., input/output devices). The input/output devices can include one or more of a microphone, speakers, headphones, display device, mouse, keyboard, game controller, touchscreen, virtual reality consoles, etc.

A developer device 1530 can include a virtual experience application 1532, and input/output (I/O) interfaces 1534 (e.g., input/output devices). The input/output devices can include one or more of a microphone, speakers, headphones, display device, mouse, keyboard, game controller, touchscreen, virtual reality consoles, etc.

System architecture 1500 is provided for illustration. In different implementations, the system architecture 1500 may include the same, fewer, more, or different elements configured in the same or different manner as that shown in FIG. 15.

In some implementations, network 1522 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 1520 may be a non-transitory computer readable memory (e.g., random access memory), a cache, a drive (e.g., a hard drive), a flash drive, a database system, or another type of component or device capable of storing data. The data store 1520 may also include multiple storage components (e.g., multiple drives or multiple databases) that may also span multiple computing devices (e.g., multiple server computers). In some implementations, data store 1520 may include cloud-based storage.

In some implementations, the online virtual experience server 1502 can include a server having one or more computing devices (e.g., a cloud computing system, a rackmount server, a server computer, cluster of physical servers, etc.). In some implementations, the online virtual experience server 1502 may be an independent system, may include multiple servers, or be part of another system or server.

In some implementations, the online virtual experience server 1502 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 1502 and to provide a user with access to online virtual experience server 1502. The online virtual experience server 1502 may also include a website (e.g., a web page) or application back-end software that may be used to provide a user with access to content provided by online virtual experience server 1502. For example, users may access online virtual experience server 1502 using the virtual experience application 1512 on client devices 1510.

In some implementations, virtual experience session data are generated via online virtual experience server 1502, virtual experience application 1512, and/or virtual experience application 1532, and are stored in data store 1520. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 1502 may be a type of social network providing connections between users or a type of user-generated content system that allows users (e.g., end-users or consumers) to communicate with other users on the online virtual experience server 1502, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 1520 or within virtual experiences 1506. The data store 1520 may be utilized to store chat transcripts (text, audio, images, etc.) exchanged between participants, with appropriate permissions from the players and in compliance with applicable regulations.

In some implementations, the chat transcripts are generated via virtual experience application 1512 and/or virtual experience application 1532 or and are stored in data store 1520. The chat transcripts may include the chat content and associated metadata, e.g., text content of chat with each message having a corresponding sender and recipient(s); message formatting (e.g., bold, italics, loud, etc.); message timestamps; relative locations of participant avatar(s) within a virtual experience environment, accessories utilized by virtual experience participants, etc. In some implementations, the chat transcripts may include multilingual content, and messages in different languages from different sessions of a virtual experience may be stored in data store 1520.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. Other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 1502 may be a virtual gaming server. For example, the gaming server may provide single-player or multiplayer games to a community of users that may access as “system” herein) includes online virtual experience server 1502, data store 1520, client or interact with virtual experiences using client devices 1510 via network 1522. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 1510) within a virtual experience (e.g., 1506) or the presentation of the interaction on a display or other output device (e.g., 1514) of a client device 1510. For example, virtual experience engagement may include interactions with one or more participants within a virtual experience or the presentation of the interactions on a display of a client device.

In some implementations, a virtual experience 1506 can include an electronic file that can be executed or loaded using software, firmware or hardware configured to present the virtual experience content (e.g., digital media item) to an entity. In some implementations, a virtual experience application 1512 may be executed and a virtual experience 1506 rendered in connection with a virtual experience engine 1504. In some implementations, a virtual experience 1506 may have a common set of rules or common goal, and the environment of a virtual experience 1506 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 1506 may be collectively referred to as a “world” or “virtual experience world” or “gaming world” or “virtual world” or “universe” herein. An example of a world may be a 3D world of a virtual experience 1506. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 1502 can host one or more virtual experiences 1506 and can permit users to interact with the virtual experiences 1506 using a virtual experience application 1512 of client devices 1510. Users of the online virtual experience server 1502 may play, create, interact with, or build virtual experiences 1506, communicate with other users, and/or create and build objects (e.g., also referred to as “item(s)” or “virtual experience objects” or “virtual experience item(s)” herein) of virtual experiences 1506.

For example, in generating user-generated virtual items, users may create characters, decoration for the characters, one or more virtual environments for an interactive virtual experience, or build structures used in a virtual experience 1506, among others. In some implementations, users may buy, sell, or trade virtual experience objects, such as in-platform currency (e.g., virtual currency), with other users of the online virtual experience server 1502. In some implementations, online virtual experience server 1502 may transmit virtual experience content to virtual experience applications (e.g., 1512). In some implementations, virtual experience content (also referred to as “content” herein) may refer to any data or software instructions (e.g., virtual experience objects, virtual experience, user information, video, images, commands, media item, etc.) associated with online virtual experience server 1502 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience 1506 of the online virtual experience server 1502 or virtual experience applications 1512 of the client devices 1510. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 1502 hosting virtual experiences 1506, is provided for purposes of illustration. In some implementations, online virtual experience server 1502 may host one or more media items that can include communication messages from one user to one or more other users. With user permission and express user consent, the online virtual experience server 1502 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 1506 may be associated with a particular user or a particular group of users (e.g., a private virtual experience), or made widely available to users with access to the online virtual experience server 1502 (e.g., a public virtual experience). In some implementations, where online virtual experience server 1502 associates one or more virtual experiences 1506 with a specific user or group of users, online virtual experience server 1502 may associate the specific user(s) with a virtual experience 1506 using user account information (e.g., a user account identifier such as username and password).

In some implementations, online virtual experience server 1502 or client devices 1510 may include a virtual experience engine 1504 or virtual experience application 1512. In some implementations, virtual experience engine 1504 may be used for the development or execution of virtual experiences 1506. For example, virtual experience engine 1504 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 1504 may generate commands that help compute and render the virtual experience (e.g., rendering commands, collision commands, physics commands, etc.) In some implementations, virtual experience applications 1512 of client devices 1510, respectively, may work independently, in collaboration with virtual experience engine 1504 of online virtual experience server 1502, or a combination of both.

In some implementations, both the online virtual experience server 1502 and client devices 1510 may execute a virtual experience engine/application (1504 and 1512, respectively). The online virtual experience server 1502 using virtual experience engine 1504 may perform some or all the virtual experience engine functions (e.g., generate physics commands, rendering commands, etc.), or offload some or all the virtual experience engine functions to virtual experience engine 1504 of client device 1510. In some implementations, each virtual experience 1506 may have a different ratio between the virtual experience engine functions that are performed on the online virtual experience server 1502 and the virtual experience engine functions that are performed on the client devices 1510. For example, the virtual experience engine 1504 of the online virtual experience server 1502 may be used to generate physics commands in cases where there is a collision between at least two virtual experience objects, while the additional virtual experience engine functionality (e.g., generate rendering commands) may be offloaded to the client device 1510. In some implementations, the ratio of virtual experience engine functions performed on the online virtual experience server 1502 and client device 1510 may be changed (e.g., dynamically) based on virtual experience engagement conditions. For example, if the number of users engaging in a particular virtual experience 1506 exceeds a threshold number, the online virtual experience server 1502 may perform one or more virtual experience engine functions that were previously performed by the client devices 1510.

For example, users may be playing a virtual experience 1506 on client devices 1510, and may send control instructions (e.g., user inputs, such as right, left, up, down, user election, or character position and velocity information, etc.) to the online virtual experience server 1502. Subsequent to receiving control instructions from the client devices 1510, the online virtual experience server 1502 may send experience instructions (e.g., position and velocity information of the characters participating in the group experience or commands, such as rendering commands, collision commands, etc.) to the client devices 1510 based on control instructions. For instance, the online virtual experience server 1502 may perform one or more logical operations (e.g., using virtual experience engine 1504) on the control instructions to generate experience instruction(s) for the client devices 1510. In other instances, online virtual experience server 1502 may pass one or more or the control instructions from one client device 1510 to other client devices (e.g., from client device 1510a to client device 1510b) participating in the virtual experience 1506. The client devices 1510 may use the experience instructions and render the virtual experience for presentation on the displays of client devices 1510.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 1502. In other implementations, the control instructions may be sent from a client device 1510 to another client device (e.g., from client device 1510b to client device 1510n), where the other client device generates experience instructions using the local virtual experience engine 1504. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 1510 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc. is provided as illustration. In some implementations, any number of client devices 1510 may be used.

In some implementations, each client device 1510 may include an instance of the virtual experience application 1512, respectively. In one implementation, the virtual experience application 1512 may permit users to use and interact with online virtual experience server 1502, such as control a virtual character in a virtual experience hosted by online virtual experience server 1502, or view or upload content, such as virtual experiences 1506, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 1510 and allows users to interact with online virtual experience server 1502. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, upload content to the online virtual experience server 1502 as well as interact with online virtual experience server 1502 (e.g., engage in virtual experiences 1506 hosted by online virtual experience server 1502). As such, the virtual experience application may be provided to the client device(s) 1510 by the online virtual experience server 1502. In another example, the virtual experience application may be an application that is downloaded from a server.

In some implementations, each developer device 1530 may include an instance of the virtual experience application 1532, respectively. In one implementation, the virtual experience application 1532 may permit a developer user(s) to use and interact with online virtual experience server 1502, such as control a virtual character in a virtual experience hosted by online virtual experience server 1502, or view or upload content, such as virtual experiences 1506, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to developer device 1530 and allows users to interact with online virtual experience server 1502. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 1532 may be an online virtual experience server application for users to build, create, edit, upload content to the online virtual experience server 1502 as well as interact with online virtual experience server 1502 (e.g., provide and/or engage in virtual experiences 1506 hosted by online virtual experience server 1502). As such, the virtual experience application may be provided to the developer device(s) 1530 by the online virtual experience server 1502. In another example, the virtual experience application 1532 may be an application that is downloaded from a server. Virtual experience application 1532 may be configured to interact with online virtual experience server 1502 and obtain access to user credentials, user currency, etc. for one or more virtual experiences 1506 developed, hosted, or provided by a virtual experience developer.

In some implementations, a user may login to online virtual experience server 1502 via the virtual experience application. The user may access a user account by providing user account information (e.g., username and password) where the user account is associated with one or more characters available to participate in one or more virtual experiences 1506 of online virtual experience server 1502. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 1502 can also be performed by the client device(s) 1510, or a server, in other implementations if appropriate. In addition, the functionality attributed to a particular component can be performed by different or multiple components operating together. The online virtual experience server 1502 can also be accessed as a service provided to other systems or devices through suitable application programming interfaces (APIs), and thus is not limited to use in websites.

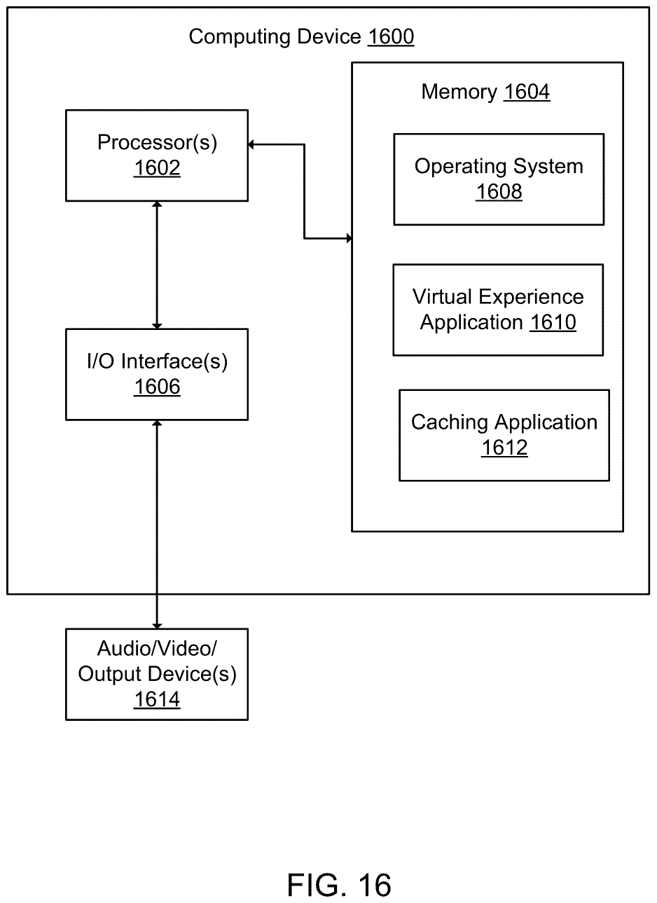

### FIG. 16—Example Computing Device

FIG. 16 is a block diagram that illustrates an example computing device 1600 which may be used to implement one or more features described herein, in accordance with some implementations. In one example, computing device 1600 may be used to implement a computer device (e.g., 1502 and/or 1510 of FIG. 15), and perform appropriate method implementations described herein. Computing device 1600 can be any suitable computer system, server, or other electronic or hardware device. For example, the computing device 1600 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, computing device 1600 includes a processor 1602, a memory 1604, input/output (I/O) interfaces 1606, and audio/video input/output devices 1614.

Processor 1602 can be one or more processors and/or processing circuits to execute program code and control basic operations of the computing device 1600. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1604 is typically provided in computing device 1600 for access by the processor 1602, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1602 and/or integrated therewith. Memory 1604 can store software operating on the computing device 1600 by the processor 1602, including an operating system 1608, a virtual experience application 1610, a caching application 1612, and other applications (not shown). In some implementations, virtual experience application 1610 and/or caching application 1612 can include instructions that enable processor 1602 to perform the functions (or control the functions of) described herein, e.g., some or all of the methods described with respect to FIGS. 9 and 13-14.

For example, virtual experience application 1610 can include a caching application 1612, which as described herein can manage caching for a diffusion model (such as a diffusion transformer) within an online virtual experience server (e.g., 1502). Elements of software in memory 1604 can alternatively be stored on any other suitable storage location or computer-readable medium. In addition, memory 1604 (and/or other connected storage device(s)) can store instructions and data used in the features described herein. Memory 1604 and any other type of storage (magnetic disk, optical disk, magnetic tape, or other tangible media) can be considered “storage” or “storage devices.”

I/O interface(s) 1606 can provide functions to enable interfacing the computing device 1600 with other systems and devices. For example, network communication devices, storage devices (e.g., memory and/or data store 1520), and input/output devices can communicate via I/O interface(s) 1606. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 1614 can include a user input device (e.g., a mouse, etc.) that can be used to receive user input, a display device (e.g., screen, monitor, etc.) and/or a combined input and display device, that can be used to provide graphical and/or visual output.

For ease of illustration, FIG. 16 shows one block for each of processor 1602, memory 1604, I/O interface(s) 1606, and software blocks of operating system 1608, virtual experience application 1610, and caching application 1612. These blocks may represent one or more processors or processing circuitries, operating systems, memories, I/O interfaces, applications, and/or software engines. In other implementations, computing device 1600 may not have all of the components shown and/or may have other elements including other types of elements instead of, or in addition to, those shown herein. While the online virtual experience server 1502 is described as performing operations as described in some implementations herein, any suitable component or combination of components of online virtual experience server 1502 or similar system, or any suitable processor or processors associated with such a system, may perform the operations described.

A user device can also implement and/or be used with features described herein. Example user devices can be computer devices including some similar components as the computing device 1600, e.g., processor(s) 1602, memory 1604, and I/O interface(s) 1606. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 1614, for example, can be connected to (or included in) the computing device 1600 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., methods 900, 1300, and 1400) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to obtain inference output from a diffusion model that includes a plurality of blocks (N), each block including one or more layers, and wherein obtaining the inference output is by performing a plurality of sequential passes of the diffusion model, the method comprising:
performing a first pass of the diffusion model by executing the plurality of blocks to obtain a first-pass output;
for each subsequent pass,
determining whether to execute one or more specified layers in the plurality of blocks based on a data structure that indicates skippable layers;
if it is determined to execute the one or more specified layers in the plurality of blocks, performing a pass of the diffusion model based on previous pass output from an immediately preceding pass by executing the one or more specified layers in the plurality of blocks to obtain outputs for the one or more specified layers; and
if it is determined to not execute the one or more specified layers in the plurality of blocks, performing the pass of the diffusion model based on the previous pass output from the immediately preceding pass by accessing respective layer output values for the one or more specified layers in the plurality of blocks from the immediately preceding pass, wherein a computational cost associated with accessing the respective layer output values is lower than a computational cost associated with executing the one or more specified layers; and
at a final pass, receiving the inference output at an output layer of the diffusion model.

2. The computer-implemented method of claim 1, wherein the diffusion model is an image generation model that generates an output image by denoising a noisy input image, and wherein performing the first pass comprises performing the first pass using the noisy input image as an input to the diffusion model.

3. The computer-implemented method of claim 1, wherein the diffusion model is a speech-to-speech model that generates output speech based on input speech.

4. The computer-implemented method of claim 1, wherein each pass of the plurality of sequential passes of the diffusion model is associated with a respective timestep, and wherein the data structure is indexed by the timestep, such that the data structure indicates whether the one or more specified layers in the plurality of blocks are to be executed for the timestep.

5. The computer-implemented method of claim 1, further comprising generating the data structure that indicates whether to execute the one or more specified layers by performing one or more calibration runs, wherein each calibration run comprises:
performing a plurality of sequential calibration passes of the diffusion model by executing the one or more layers of the plurality of blocks to obtain respective calibration pass output, wherein each successive calibration pass uses a previous calibration pass output as input;
during the sequential calibration passes, determining a value of a loss function (E (L₁, L₂)) based on comparison of the calibration pass output for each pass of a respective layer with the calibration pass output of an immediately preceding pass for the respective layer; and
if the value of the loss function meets a threshold, updating the data structure to indicate that the respective layer is skippable for the pass.

6. The computer-implemented method of claim 5, wherein each calibration run further comprises if the value of the loss function does not meet the threshold, updating the data structure to indicate that the respective layer is not skippable for the pass.

7. The computer-implemented method of claim 5, further comprising:
computing error curves associated with output error of the diffusion model with respective test caching strategies for a layer; and
updating the data structure based on the error curves to provide a caching schedule for the layer.

8. The computer-implemented method of claim 1, wherein the diffusion model includes additional units that precede and/or succeed the plurality of blocks, and wherein the additional units are executed at each pass of the plurality of sequential passes of the diffusion model.

9. The computer-implemented method of claim 8, wherein the additional units succeed the plurality of blocks and include at least one of a layer normalization unit or a linearize-and-reshape unit.

10. The computer-implemented method of claim 8, wherein the additional units precede the plurality of blocks and include an embedding generation unit.

11. A non-transitory computer-readable medium with instructions stored thereon that, responsive to execution by a processing device, causes the processing device to perform a computer-implemented method to obtain inference output from a diffusion model that includes a plurality of blocks (N), each block including one or more layers, and wherein obtaining the inference output is by performing a plurality of sequential passes of the diffusion model by performing operations comprising:
performing a first pass of the diffusion model by executing the plurality of blocks to obtain a first-pass output;
for each subsequent pass,
determining whether to execute one or more specified layers in the plurality of blocks based on a data structure that indicates skippable layers;
if it is determined to execute the one or more specified layers in the plurality of blocks, performing a pass of the diffusion model based on previous pass output from an immediately preceding pass by executing the one or more specified layers in the plurality of blocks to obtain outputs for the one or more specified layers; and
if it is determined to not execute the one or more specified layers in the plurality of blocks, performing the pass of the diffusion model based on the previous pass output from the immediately preceding pass by accessing respective layer output values for the one or more specified layers in the plurality of blocks from the immediately preceding pass, wherein a computational cost associated with accessing the respective layer output values is lower than a computational cost associated with executing the one or more specified layers; and
at a final pass, receiving the inference output at an output layer of the diffusion model.

12. The non-transitory computer-readable medium of claim 11, wherein the instructions cause the processing device to perform further operations comprising generating the data structure that indicates whether to execute the one or more specified layers by performing one or more calibration runs, wherein each calibration run comprises:
performing a plurality of sequential calibration passes of the diffusion model by executing the one or more layers of the plurality of blocks to obtain respective calibration pass output, wherein each successive calibration pass uses a previous calibration pass output as input;
during the sequential calibration passes, determining a value of a loss function (E (L₁, L₂)) based on comparison of the calibration pass output for each pass of a respective layer with the calibration pass output of an immediately preceding pass for the respective layer; and
if the value of the loss function meets a threshold, updating the data structure to indicate that the respective layer is skippable for the pass.

13. The non-transitory computer-readable medium of claim 12, wherein the instructions cause the processing device to perform further operations further comprising:
computing error curves associated with output error of the diffusion model with respective test caching strategies for a layer; and
updating the data structure based on the error curves to provide a caching schedule for the layer.

14. The non-transitory computer-readable medium of claim 11, wherein the diffusion model includes additional units that precede and/or succeed the plurality of blocks, and wherein the additional units are executed at each pass of the plurality of sequential passes of the diffusion model.

15. The non-transitory computer-readable medium of claim 14, wherein the additional units succeed the plurality of blocks and include at least one of a layer normalization unit or a linearize-and-reshape unit.

16. The non-transitory computer-readable medium of claim 14, wherein the additional units precede the plurality of blocks and include an embedding generation unit.

17. A system, comprising:
a memory with instructions stored thereon; and
a processing device, coupled to the memory, the processing device configured to access the memory and execute the instructions, wherein the instructions cause the processing device to perform a computer-implemented method to obtain inference output from a diffusion model that includes a plurality of blocks (N), each block including one or more layers, and wherein obtaining the inference output is by performing a plurality of sequential passes of the diffusion model by performing operations comprising:
performing a first pass of the diffusion model by executing the plurality of blocks to obtain a first-pass output;
for each subsequent pass,
determining whether to execute one or more specified layers in the plurality of blocks based on a data structure that indicates skippable layers;
if it is determined to execute the one or more specified layers in the plurality of blocks, performing a pass of the diffusion model based on previous pass output from an immediately preceding pass by executing the one or more specified layers in the plurality of blocks to obtain outputs for the one or more specified layers; and
if it is determined to not execute the one or more specified layers in the plurality of blocks, performing the pass of the diffusion model based on the previous pass output from the immediately preceding pass by accessing respective layer output values for the one or more specified layers in the plurality of blocks from the immediately preceding pass, wherein a computational cost associated with accessing the respective layer output values is lower than a computational cost associated with executing the one or more specified layers; and
at a final pass, receiving the inference output at an output layer of the diffusion model.

18. The system of claim 17, wherein the instructions cause the processing device to perform further operations comprising generating the data structure that indicates whether to execute the one or more specified layers by performing one or more calibration runs, wherein each calibration run comprises:
performing a plurality of sequential calibration passes of the diffusion model by executing the one or more layers of the plurality of blocks to obtain respective calibration pass output, wherein each successive calibration pass uses a previous calibration pass output as input;
during the sequential calibration passes, determining a value of a loss function (E (L₁, L₂)) based on comparison of the calibration pass output for each pass of a respective layer with the calibration pass output of an immediately preceding pass for the respective layer; and
if the value of the loss function meets a threshold, updating the data structure to indicate that the respective layer is skippable for the pass.

19. The system of claim 18, wherein the instructions cause the processing device to perform further operations further comprising:
computing error curves associated with output error of the diffusion model with respective test caching strategies for a layer; and
updating the data structure based on the error curves to provide a caching schedule for the layer.

20. The system of claim 17, wherein the diffusion model includes additional units that precede and/or succeed the plurality of blocks, and wherein the additional units are executed at each pass of the plurality of sequential passes of the diffusion model.
